(19) United States
(12) Patent Application Publication
(10) Pub. No.: US 2026/0289628 A1
(43) Pub. Date: Sep. 24, 2026

(54) SYSTEM

(71) Applicant: SoftBank Group Corp., Tokyo (JP)

(72) Inventor: Dai WATANABE, Tokyo (JP)

(73) Assignee: SoftBank Group Corp., Tokyo (JP)

(21) Appl. No.: 19/567,004

(22) Filed: Mar. 14, 2026

(30) Foreign Application Priority Data
Mar. 19, 2025 (JP) 2025-045092

(51) Int. Cl. G06Q 30/0601; G06N 3/045; G10L 15/22; H04L 51/02

(52) U.S. Cl. CPC G06Q 30/0624; G06N 3/045; G06Q 30/0629; G10L 15/22; H04L 51/02

(57) ABSTRACT

A system includes a processor that is configured to generate a prompt that instructs a generative AI model to automate a sales process in order to alleviate a shortage of human resources and to perform sales activities efficiently for a large number of customers, generate a prompt that instructs the generative AI model to comprehensively use product knowledge, to analyze conversation content with a customer by using natural language processing, and to generate a personalized proposal, and generate a prompt that instructs the generative AI model to acquire voice data of the customer, to analyze a tone, a volume, a speech rate, and a speech pattern of the voice data by using a voice analysis algorithm, and to analyze a psychological state of the customer.

### CROSS-REFERENCE TO RELATED APPLICATION

This application is based on and claims priority under 35 USC 119 from Japanese Patent Application No. 2025-045092 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional sales operations heavily depend on human sales representatives to handle customer inquiries, understand customer needs, explain complex product lines, and create tailored proposals. As the number of customers and the diversity of products increase, companies face a serious shortage of skilled sales personnel, which leads to limited coverage of potential customers, delays in responding to inquiries, and inconsistent quality of proposals. Furthermore, existing automation tools are typically rule-based and lack the flexibility to understand natural language conversations or to personalize recommendations at scale.

In addition, traditional systems do not effectively integrate analysis of customers' spoken communication. They generally ignore voice characteristics such as tone, volume, speech rate, and speech patterns, and they therefore fail to infer the psychological state of the customer during a sales interaction. As a result, sales responses cannot be adaptively adjusted based on customer hesitation, excitement, or other emotional cues, thereby reducing closing efficiency.

Moreover, conventional systems are often limited to a single language or require separate manual workflows for each language, making it difficult to perform efficient, consistent, and scalable multilingual sales operations. Existing tools also do not sufficiently utilize the knowledge embedded in past successful deals to automatically generate proposal documents or proposal videos that fill gaps in a current customer's selection.

Accordingly, there is a need for a system that can alleviate the shortage of human sales resources by automatically generating prompts for a generative AI model to automate key parts of the sales process, that can use comprehensive product knowledge and natural language understanding to generate personalized proposals, that can analyze voice data to infer a customer's psychological state, that can generate proposal documents and videos based on comparisons with past purchased users, and that can implement multilingual support using machine translation technology.

### SUMMARY

In order to solve the above problems, a system according to at least one embodiment of the present invention comprises a processor configured to generate and manage prompts for a generative AI model in connection with automated sales operations.

Specifically, the processor is configured to generate a prompt that instructs a generative AI model to automate a sales process so as to alleviate a shortage of human resources and to perform sales activities efficiently for a large number of customers. By generating such a prompt, the system enables the generative AI model to assume tasks that would otherwise require human sales representatives, thereby enhancing scalability and coverage of sales activities.

The processor is further configured to generate a prompt that instructs the generative AI model to comprehensively use product knowledge, to analyze conversation content with a customer by using natural language processing, and to generate a personalized proposal. Through this configuration, the system allows the generative AI model to interpret free-form customer input, retrieve and combine relevant product information, and output proposals that are tailored to the individual needs and constraints of each customer.

The processor is also configured to generate a prompt that instructs the generative AI model to acquire voice data of the customer, to analyze a tone, a volume, a speech rate, and a speech pattern of the voice data by using a voice analysis algorithm, and to analyze a psychological state of the customer. By generating this prompt, the system enables the generative AI model and associated analysis components to infer emotional or psychological states from the customer's speech characteristics, and to allow subsequent sales responses and proposals to be adapted in accordance with such inferred states.

Furthermore, in one embodiment, the processor is configured to generate a prompt that instructs the generative AI model to compare a sales result with data of purchased users and to generate a proposal document and a proposal video that fill deficient portions in the sales result. In this manner, the system utilizes historical data of successful purchasers to identify gaps in a current customer's selected products and automatically produces closing materials that suggest additional products or configurations to complete the solution.

In another embodiment, the processor is configured to generate a prompt that instructs the generative AI model to implement multilingual support by using machine translation technology. This configuration enables the generative AI model to interact with customers in multiple languages, thereby providing consistent, 24-hour, multilingual sales support without requiring separate manual workflows for each language.

By the above means, the system can automate and personalize sales processes at scale, analyze customer psychological states from voice data, leverage past successful deals to generate gap-filling proposals, and support multilingual interactions, thereby effectively solving the problems associated with human resource shortages, limited scalability, lack of emotional insight, and insufficient multilingual capability in conventional sales systems.

The term “system” refers to a combination of hardware and software components including at least one processor and associated memory, communication interfaces, and storage, configured to execute the processing described in the claims.

The term “processor” refers to one or more hardware processing units, such as a central processing unit (CPU), a graphics processing unit (GPU), an application-specific integrated circuit (ASIC), or a programmable logic device, which executes instructions to perform the functions described in the claims.

The term “generative AI model” refers to a machine learning model, such as a large language model or other neural network-based model, that is configured to generate outputs including text, prompts, documents, scripts, or other content based on input data.

The term “prompt” refers to data including instructions, context, parameters, or examples that is provided as input to the generative AI model to cause the generative AI model to perform a specific processing operation or to generate a specific type of output.

The term “sales process” refers to a sequence of operations involved in selling products or services to customers, including at least one of lead generation, needs analysis, product explanation, proposal creation, response to customer questions, negotiation, and closing.

The term “product knowledge” refers to information relating to products or services, including at least one of specifications, features, pricing, usage methods, limitations, advantages, and past customer evaluations.

The term “natural language processing” refers to a set of computational techniques for analyzing, understanding, generating, or transforming human language in text or speech form, including at least one of tokenization, parsing, intent detection, entity extraction, and response generation.

The term “personalized proposal” refers to a recommendation or offer that is automatically generated for a particular customer based on that customer's needs, preferences, constraints, history, or behavior, and that is different from a generic proposal.

The term “voice data” refers to audio data representing speech of a customer, acquired through a microphone or another audio input device, and including at least one of raw audio signals and encoded audio streams.

The term “voice analysis algorithm” refers to a computational procedure or model configured to process voice data in order to extract characteristics such as tone, volume, speech rate, and speech pattern, and optionally to infer higher-level attributes such as emotion or psychological state.

The term “tone” refers to an acoustic characteristic of voice data related to the pitch or fundamental frequency of the speech signal.

The term “volume” refers to an acoustic characteristic of voice data related to the amplitude or loudness level of the speech signal.

The term “speech rate” refers to a quantitative measure of the speed of spoken language, including at least one of words per minute, syllables per second, or phonemes per unit time.

The term “speech pattern” refers to temporal and structural characteristics of speech, including at least one of pause frequency, pause duration, intonation patterns, rhythm, and emphasis distribution.

The term “psychological state” refers to an estimated internal state of a customer, inferred from voice data or other interaction data, including at least one of hesitation, confidence, excitement, calmness, or neutrality.

The term “sales result” refers to information representing an outcome of a sales interaction with a customer, including at least one of selected products, rejected products, objections, and final deal status.

The term “purchased user” refers to a past or existing customer who has completed a purchase of at least one product or service and whose data is stored in a database for comparison with current customers.

The term “proposal document” refers to a structured text-based document generated by the system and intended to be presented to a customer, which describes recommended products or services, configurations, or terms, including information to fill deficiencies in a current sales result.

The term “proposal video” refers to an audiovisual content item generated or scripted by the system and intended to be presented to a customer, which explains recommended products or services, configurations, or terms using narration, images, animations, or other visual elements.

The term “multilingual support” refers to an ability of the system to process, understand, and respond to inputs in multiple human languages, and to provide outputs in a language suitable for each respective customer.

The term “machine translation technology” refers to software or models configured to automatically translate text or speech from one human language into another without requiring manual translation.

The term “compare” refers to processing in which data related to a current sales result is evaluated against data related to purchased users in order to identify similarities, differences, or gaps.

The term “deficient portions” refers to products, services, or configuration elements that are inferred to be missing from a current sales result when compared to purchases of similar purchased users, and that are candidates for recommendation in order to complete the customer's solution.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

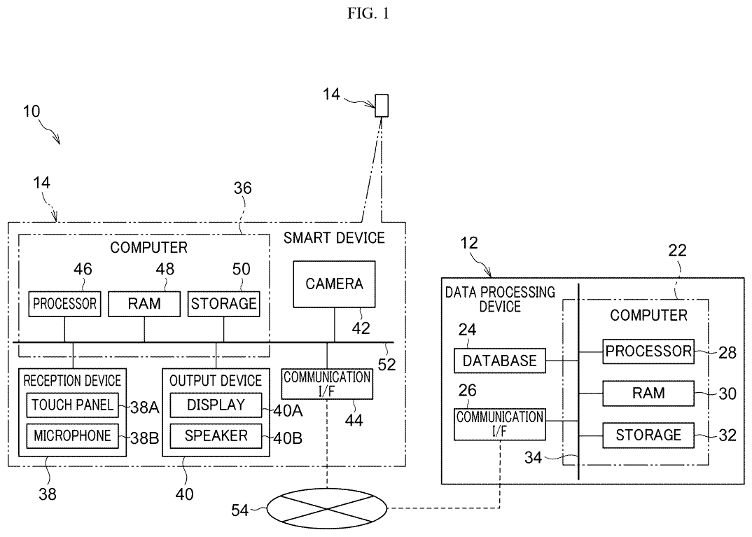

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

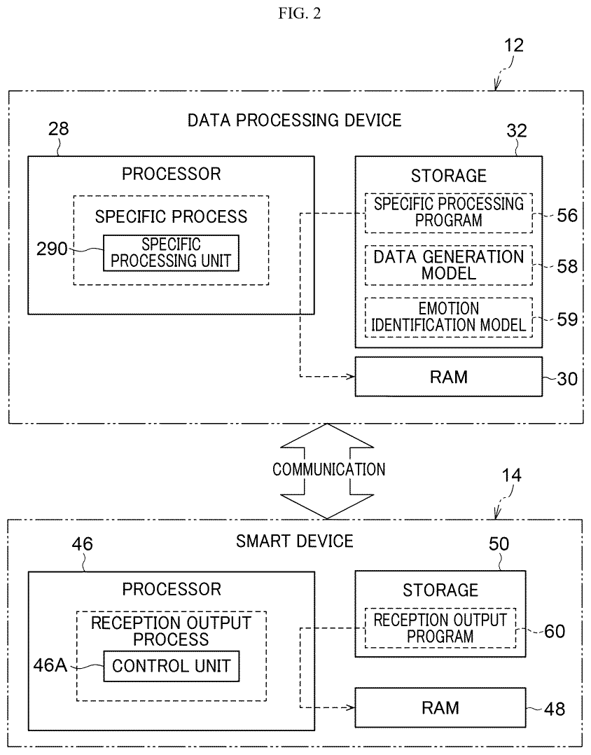

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented sales support systems primarily focus on static rule-based recommendation engines or simple retrieval of product records from a database, without deeply understanding user-entered natural language or dynamically reflecting customer reactions during a business negotiation. Such systems typically treat natural language prompts, if used at all, as superficial query strings, and do not fully exploit advanced generative AI models as core computational components for context-aware proposal generation. As a result, these systems fail to provide sufficiently personalized, negotiation-aware guidance to a salesperson and cannot significantly reduce the dependence on human expertise in complex sales scenarios.

In particular, existing systems suffer from several technical shortcomings. First, they lack a unified processing pipeline in which a processor interprets a prompt sentence entered by a user through a terminal, converts the prompt sentence into structured customer need information and constraint condition information by natural language processing, and then uses such structured information to search a product information store at scale while maintaining low latency. Second, existing architectures do not integrate a generative AI model as an internal processing engine that conditions on both retrieved product information and the extracted customer need information to generate a personalized proposal sentence as a system-generated computational output, rather than as a standalone external tool. This leads to fragmented processing, increased communication overhead, and inconsistent proposal quality.

Third, conventional systems inadequately process customer voice signals obtained during a business negotiation. They typically either ignore such signals or merely store audio data for later manual review, without performing real-time speech recognition and acoustic feature analysis to estimate a customer's psychological state. Consequently, they cannot close the loop between customer reactions and proposal refinement. The processor does not use customer tone, volume, speaking speed, and speech pattern as machine-usable features to adapt guidance and proposals during the ongoing interaction.

Fourth, current solutions do not provide a mechanism by which a processor systematically compares business negotiation result information with historical data of existing purchasers stored in a data repository, identifies missing product categories, functions, or service conditions, and automatically generates follow-up proposals using a generative AI model. This absence of automated follow-up proposal generation reduces the effectiveness and consistency of post-negotiation activities.

Fifth, existing multi-language support, when present, is usually implemented as a separate translation layer, loosely coupled with the core recommendation logic. It does not form a tightly integrated computational flow in which the same prompt sentence, generated proposal sentences, guidance sentences, and recognized customer utterances are consistently converted across multiple languages while preserving the underlying proposal logic. This results in data inconsistencies, loss of context, and additional latency.

Accordingly, there is a need for a computer-implemented system and server architecture that improves the internal processing of sales support operations by: (i) transforming free-form prompt sentences into structured condition data at the processor level, (ii) integrating a generative AI model into the core processing pipeline for generating personalized proposals, (iii) incorporating real-time voice-based psychological state estimation, (iv) automatically computing follow-up proposal content based on negotiation results and historical data, and (v) providing integrated multilingual processing. Such a system would enhance the technical functioning of the sales support platform itself, improve resource utilization and response quality, and enable the processor to execute more efficient, context-aware computations in support of sales activities.

The specific processing by the specific processing unit 290 of the data processing device 12 in Example 1 is realized by the following means.

The present invention provides a server comprising a processor, the processor being configured to function as an information storage unit that accumulates and manages, in a searchable manner, structured data including product information, price information, usage information, and evaluation information; to function as an analysis unit that receives, via a terminal, a prompt sentence input by a user, performs natural language processing on the prompt sentence including at least morphological analysis, semantic analysis, and intent estimation, and extracts customer need information and constraint condition information from the prompt sentence; to function as a proposal generation unit that, based on the customer need information and the constraint condition information, executes query processing on the information storage unit to acquire product information satisfying at least one condition, inputs the acquired product information and the customer need information as context to a generative AI model, and generates a personalized proposal sentence in natural language; to control the terminal so that the terminal functions as a presentation unit that presents the personalized proposal sentence to the user by at least one of screen display and audio output; to control the terminal so that the terminal functions as a voice acquisition unit that acquires a voice of a customer during a business negotiation by a sound collection device and transmits corresponding voice data to the processor; to function as a psychological state analysis unit that performs speech recognition processing and acoustic feature analysis processing on the voice data, estimates customer psychological state information based on at least one of tone, volume, speaking speed, and speech pattern, and inputs the psychological state information and business negotiation situation information as context to the generative AI model to generate a guidance sentence or a revised proposal sentence including at least a response policy for the user, emphasis points of explanation content, and additional information to be input; to control the terminal so that the terminal functions as a business negotiation support unit that presents the guidance sentence or the revised proposal sentence to the user during the business negotiation and supports real-time adjustment of explanation content by the user; to function as a follow-up proposal generation unit that compares result information of the business negotiation with history information related to existing purchasers accumulated in the information storage unit, identifies at least one missing product category, function, or service condition, generates, by using the generative AI model, a follow-up proposal sentence, proposal document structure information, or proposal video script that supplements the at least one missing item, and transmits the generated follow-up proposal sentence, proposal document structure information, or proposal video script to the terminal; and to function as a multilingual support unit that combines natural language processing and machine translation to mutually convert, between a plurality of languages, the prompt sentence input by the user, the proposal sentence and the guidance sentence generated by the generative AI model, and customer utterance text obtained by speech recognition, thereby enabling provision of personalized proposals based on a common proposal logic to customers using different languages. This enables an improved computer-implemented sales support platform in which the processor executes an integrated sequence of natural language understanding, database querying, generative AI-based proposal generation, voice-based psychological state estimation, automatic follow-up proposal generation, and multilingual conversion, thereby enhancing processing efficiency, contextual accuracy, and adaptability of the system compared with conventional rule-based or non-integrated architectures.

The term “information storage unit” refers to a logical function of the processor, implemented by execution of program code and use of a memory device, that accumulates, structures, indexes, and manages data so that the data can be efficiently searched and retrieved based on one or more conditions.

The term “product information” refers to data representing attributes of goods or services, including at least identification data, feature data, specification data, and category data that are usable for selection, comparison, and recommendation processing.

The term “price information” refers to data indicating monetary values associated with goods or services, including at least base prices, discount conditions, subscription fees, and other cost-related parameters used in proposal generation and comparison.

The term “usage information” refers to data indicating how goods or services are used, including at least operation methods, application scenarios, recommended procedures, and usage constraints that can be presented to a customer as part of a proposal.

The term “evaluation information” refers to data representing assessments of goods or services, including at least ratings, reviews, feedback summaries, and performance indicators derived from users or measurement systems.

The term “terminal” refers to an electronic device operated by a user, such as a computing device, communication device, or display device, that transmits input data including a prompt sentence to the server and presents output data including proposal sentences and guidance sentences to the user.

The term “prompt sentence” refers to a text input expressed in natural language by a user, which describes at least a customer need, a constraint condition, or a request for proposal generation, and which is supplied to a generative AI model or to a natural language processing component as an instruction or query.

The term “analysis unit” refers to a logical function of the processor that receives the prompt sentence and applies natural language processing operations, including but not limited to tokenization, morphological analysis, syntactic parsing, semantic analysis, and intent estimation, to derive structured information usable for subsequent computational steps.

The term “customer need information” refers to structured data representing at least requirements, preferences, priorities, and objectives of a customer, extracted from a prompt sentence or other input through natural language processing.

The term “constraint condition information” refers to structured data representing at least limitations, boundaries, or conditions, such as budget limits, time constraints, or technical restrictions, extracted from a prompt sentence or other input through natural language processing.

The term “proposal generation unit” refers to a logical function of the processor that performs query processing against the information storage unit based on customer need information and constraint condition information, selects product information satisfying conditions, and invokes a generative AI model with the selected product information and the customer need information as context to generate a personalized proposal sentence.

The term “generative AI model” refers to a machine learning model, typically a deep neural network trained on large-scale data, that generates output data such as text by probabilistic inference conditioned on input data, including at least a prompt sentence, context data, or structured information.

The term “personalized proposal sentence” refers to natural language text generated by the system, which describes one or more goods or services and is tailored to a particular customer based on customer need information, constraint condition information, and product information.

The term “presentation unit” refers to a logical function in which the processor controls the terminal to output data to a user by means of a display device, audio device, or other output interface, so that the user can perceive a proposal sentence or guidance sentence.

The term “voice acquisition unit” refers to a logical function in which the processor controls the terminal to operate a sound collection device, such as a microphone, to capture a customer's speech during a business negotiation and to convert the captured speech into digital voice data transmitted to the processor.

The term “sound collection device” refers to a hardware component, such as a microphone or an array microphone, which converts acoustic signals into electrical or digital signals suitable for processing by the terminal and the server.

The term “voice data” refers to digital data representing an audio signal obtained from a customer's speech, which can be processed by speech recognition and acoustic analysis algorithms.

The term “psychological state analysis unit” refers to a logical function of the processor that performs speech recognition on voice data, analyzes acoustic features including at least tone, volume, speaking speed, and speech pattern, and estimates a customer's psychological state information, such as interest, hesitation, satisfaction, or anxiety.

The term “speech recognition processing” refers to a computational operation that converts input voice data into text data by recognizing linguistic content of the speech using pattern recognition or machine learning algorithms.

The term “acoustic feature analysis processing” refers to a computational operation that extracts and analyzes numerical features from voice data, including but not limited to pitch, energy, duration, temporal variation, and prosodic patterns, to infer non-linguistic characteristics of speech.

The term “psychological state information” refers to structured data indicating an inferred internal state of a customer, including at least one of emotional state, engagement level, confidence level, or intention, derived from voice data and optionally from other contextual information.

The term “business negotiation situation information” refers to structured data representing at least a phase, topic, history, or outcome tendency of an ongoing or past business negotiation, which can be used as context for proposal generation or guidance generation.

The term “guidance sentence” refers to natural language text generated by the system that provides instructions, suggestions, or strategies to a user on how to respond to a customer, what points to emphasize, or what additional information to present during a business negotiation.

The term “revised proposal sentence” refers to a modified or updated proposal sentence generated in response to new information, including psychological state information or negotiation progress, that adjusts content, emphasis, or structure relative to an earlier proposal sentence.

The term “business negotiation support unit” refers to a logical function in which the processor controls the terminal to present guidance sentences or revised proposal sentences to the user during a business negotiation, thereby enabling real-time adjustment of the user's explanation content and interaction strategy.

The term “follow-up proposal generation unit” refers to a logical function of the processor that compares business negotiation result information with history information related to existing purchasers, identifies missing product categories, functions, or service conditions, and uses a generative AI model to generate follow-up proposal content that supplements the identified missing items.

The term “business negotiation result information” refers to structured data describing an outcome or intermediate state of a business negotiation, including at least purchased items, rejected items, pending issues, and customer feedback, which is used for subsequent analysis and follow-up proposal generation.

The term “history information related to existing purchasers” refers to data accumulated in the information storage unit that describes past purchase records, preferences, behaviors, and interaction logs of customers who have already purchased goods or services.

The term “proposal document structure information” refers to structured data defining an arrangement, hierarchy, or layout of elements in a proposal document, including sections, headings, item listings, and explanatory texts, which can be used to generate a formatted document.

The term “proposal video script” refers to text content that specifies narration, scenes, or on-screen elements for creating a video that explains or promotes goods or services as part of a proposal.

The term “multilingual support unit” refers to a logical function of the processor that integrates natural language processing and machine translation to convert prompt sentences, proposal sentences, guidance sentences, and recognized customer utterance text between multiple languages while preserving semantic content and proposal logic.

The term “machine translation” refers to a computational process that automatically converts a text expressed in a source language into a corresponding text expressed in a target language using statistical, rule-based, neural network, or hybrid translation models.

The term “common proposal logic” refers to a language-independent set of rules, conditions, and reasoning patterns used by the system to select products, generate proposals, and provide guidance, which can be applied consistently across different languages by means of multilingual processing.

In one embodiment, a server, a terminal, and a user cooperate to implement the present invention. The server includes at least one processor, a main memory, a nonvolatile storage device, and a network interface. The server executes an operating system, a database management system, and an application program implementing the functions of an information storage unit, an analysis unit, a proposal generation unit, a psychological state analysis unit, a follow-up proposal generation unit, and a multilingual support unit. The terminal includes a processor, a memory, a display device, an audio device, and a sound collection device such as a microphone, and executes a client application or a web browser to communicate with the server over a network.

The server uses, as an example of hardware, a general-purpose server-class computer or a virtual machine instance on a cloud computing platform employing a multi-core central processing unit and, when high throughput is desired, a graphics processing unit such as a parallel processing accelerator compliant with general-purpose GPU APIs. The server uses, as an example of software, a Unix-like operating system, a relational database management system such as a structured query language engine, and an application framework such as a web application framework. The server further uses a numerical computation framework such as a tensor-based library and a machine learning framework such as a deep learning library to execute a generative AI model and auxiliary neural network models.

The server stores, in a storage device, structured data representing product information, price information, usage information, and evaluation information. The server defines, for example, a product table, a price table, a usage table, and an evaluation table in a relational database. Each product record includes an identifier, a category code, feature descriptors, and specification values. The server associates price records with product records via foreign keys and stores base price values, discount rules, and currency codes. The server stores usage information as text descriptions, usage scenarios, and rule constraints, and stores evaluation information as numeric rating values, review texts, and derived indicators. The server creates indexes on frequently accessed attributes such as product category, price range, and rating, so that the processor can execute search queries with low latency. This structured storage and indexing improve data retrieval efficiency and reduce computational cost compared to unstructured storage.

The server receives, from the terminal, a prompt sentence that the user inputs through a user interface of a client application. The terminal displays a text input field on the display device, accepts keystrokes or touch input, and sends the entered prompt sentence to the server via a communication protocol such as an HTTP-based or WebSocket-based protocol over a secure channel. The user enters, for example, a prompt sentence such as:

“Please generate an optimal proposal for a customer who is looking for environmentally friendly products.”

or

“Create a proposal for a customer who wants an eco-friendly product but has a strict budget under 500 dollars.”

or

“Please summarize the main needs of a customer who wants to reduce energy consumption in their office and propose three suitable products from our catalog.”

The server uses the analysis unit to convert the received prompt sentence into structured representations. The server first tokenizes the prompt sentence into subword units using a tokenizer compatible with a transformer-based model. The server performs morphological analysis and part-of-speech tagging using a natural language processing library, and performs dependency parsing to identify relations between tokens. The server computes semantic embeddings of tokens and sentences using a pre-trained encoder network, such as a transformer encoder with multiple attention heads and multiple layers. By applying an intent classification network trained on labeled examples, the server determines categories such as “environmental preference,” “budget constraint,” “performance requirement,” and “language preference.” The server extracts entities such as price limits, product categories, and constraint phrases using a named entity recognition model. The server aggregates these extracted elements into customer need information and constraint condition information represented as structured data, for example as records with fields for required attributes, excluded attributes, numeric ranges, and priority scores.

The server uses the proposal generation unit to search the information storage unit based on the structured customer need information and constraint condition information. The server formulates database queries that include equality conditions, range conditions, and sorting conditions. For example, when the customer need information indicates “environmentally friendly” and a budget limit, the server adds a condition for an environmental attribute flag in the product table and a condition for price values below a threshold. The server executes the query using the relational database management system and obtains candidate product records. When free-text fields such as usage descriptions or review texts are used for matching, the server may use an inverted index and a ranked retrieval algorithm to compute relevance scores. This hybrid combination of structured filtering and relevance scoring reduces the number of candidates passed to the generative AI model, thereby lowering computational load and improving end-to-end response time.

The server uses a generative AI model to generate a personalized proposal sentence in natural language. In one embodiment, the server uses a transformer-based autoregressive language model with multiple self-attention layers, each layer including attention heads, feed-forward networks, normalization layers, and residual connections. The server trains the model on a corpus including product descriptions, sales conversation transcripts, and proposal documents, so that the model learns domain-specific patterns. During inference, the server constructs an input sequence that concatenates a representation of the customer need information, a summary of relevant product attributes, and instruction tokens indicating that a proposal should be generated. The server encodes these tokens, applies self-attention to compute context-aware hidden states, and generates output tokens one by one according to a probability distribution computed at each step. The server uses decoding strategies such as constrained beam search or nucleus sampling to balance diversity and consistency. The server may impose constraints by masking token probabilities so that the generated text remains consistent with product attributes and constraint conditions. This constrained decoding reduces hallucination and improves factual accuracy of proposals.

The server sends the generated proposal sentence to the terminal. The terminal receives the proposal sentence as part of a response message, renders the text on the display device with a layout optimized for readability, and, if requested by the user, uses a text-to-speech engine to synthesize audio output via the audio device. The terminal may segment the proposal into sections such as “summary,” “product list,” and “benefits,” and provide navigation controls. This arrangement allows the user to quickly locate key elements and reduces cognitive load. The user presents the proposal to a customer during a business negotiation. The terminal operates the sound collection device to capture the customer's voice. The terminal samples the audio signal, digitizes it into pulse-code modulated samples, optionally compresses the data using an audio codec, and sends the voice data to the server. The server receives the voice data and stores it temporarily in a buffer for analysis.

The server uses the psychological state analysis unit to process the voice data. The server executes a speech recognition model, such as a convolutional-recurrent hybrid or a transformer-based acoustic model combined with a language model, to convert the voice data into text. The server then computes acoustic features such as pitch contours, energy levels, spectral features, speaking rate, and pause patterns. The server aggregates these features into fixed-length vectors for segments of the conversation. The server applies an emotion and state classification neural network, for example a network combining convolutional layers for local feature extraction and recurrent or transformer layers for temporal modeling, to map acoustic feature vectors and recognized text into psychological state information. The psychological state information may include indicators such as “high interest,” “cost anxiety,” “confusion,” or “agreement tendency,” each with a confidence score. The server may also compute trend information, for example changes in interest level over time, by analyzing sequences of state estimates.

The server uses the psychological state information and business negotiation situation information as context for the generative AI model. The server constructs an input sequence that includes the current proposal content, the recognized customer utterances, and symbolic codes representing psychological states and negotiation phase. The generative AI model, which may share architecture with or be separate from the proposal model, generates a guidance sentence suggesting how the user should respond, such as emphasizing particular benefits, addressing identified concerns, or clarifying misunderstood points. The model may also generate a revised proposal sentence that reorders product recommendations or introduces alternative options. Because the model receives structured psychological state features, the processing is not a simple repetition of the initial proposal but a contextually adapted generation based on observed behavior, which reduces the need for manual interpretation by the user and allows more consistent and timely adjustments.

The server sends the guidance sentence or revised proposal sentence to the terminal. The terminal displays this content in a dedicated guidance area, separate from the customer-facing content, so that the user can see recommendations without exposing them to the customer. The terminal may highlight urgent recommendations, such as a sudden decrease in interest level, using visual cues. By integrating real-time psychological analysis with proposal generation, the system improves the responsiveness of the user's interaction and reduces missed opportunities that might occur due to delayed human-only analysis.

The server further uses the follow-up proposal generation unit after a business negotiation.

The server stores business negotiation result information including purchased items, rejected items, unresolved questions, and customer feedback. The server compares this result information with history information related to existing purchasers stored in the information storage unit. The server uses statistical methods or machine learning models such as collaborative filtering or similarity-based retrieval to identify product categories, functions, or service conditions that have been frequently selected by similar customers but are absent from the current negotiation result. The server encodes these missing elements as additional need signals and invokes the generative AI model to generate follow-up proposal content, such as a follow-up proposal sentence, proposal document structure information, or a proposal video script. The server sends this content to the terminal for use in subsequent communications. This automated follow-up mechanism increases coverage of relevant offerings and reduces manual analysis time.

The server implements a multilingual support unit to handle interactions in multiple languages. The server uses a machine translation model, for example a neural encoder-decoder with attention, to convert prompt sentences, proposal sentences, guidance sentences, and recognized customer utterance text between languages. In one embodiment, the server maintains an internal representation in a base language and performs translation at the boundaries of the processing pipeline, so that internal logic, including product selection and proposal composition, is consistent regardless of the external language. The server may also employ a multilingual generative AI model that directly supports multiple languages by sharing internal parameters across languages. By architecting the system so that the same proposal logic operates on language-independent representations, the system avoids divergence in behavior across languages and improves maintainability and accuracy of multilingual operation.

The server achieves improvements in computer technology by implementing specific data structures, processing flows, and model architectures that reduce computational load, improve accuracy, and enhance responsiveness. The conversion of free-form prompt sentences into structured customer need information and constraint condition information allows the server to filter and sort products using efficient database operations, which reduces the amount of data processed by the generative AI model and thereby reduces inference time and memory usage. The use of constrained decoding and context-aware conditioning on structured data improves factual accuracy and consistency of generated text, reducing the need for repeated queries and corrections. The integration of speech recognition, acoustic feature analysis, and psychological state classification into a feedback loop with proposal generation allows the server to adapt outputs in real time based on machine-detectable signals that humans cannot reliably quantify at high speed, such as subtle changes in prosody. This technical configuration improves the system's ability to process streaming data within latency constraints and to provide timely guidance.

The server trains the generative AI model and the auxiliary models using supervised or semi-supervised learning on recorded data. The server defines an objective function, such as a cross-entropy loss between predicted tokens and reference tokens for text generation, and a classification loss for psychological state prediction. The server uses gradient-based optimization, such as stochastic gradient descent with variants like Adam, to update model parameters. The server may use techniques such as learning rate scheduling, regularization, dropout, and data augmentation to improve generalization. For psychological state models, the server may augment training data by perturbing acoustic features within ranges that preserve perceptual characteristics, thereby increasing robustness to noise and recording variations. These training details contribute to improved accuracy and stability of the deployed models.

The server, the terminal, and the user operate together in multiple implementation variants. In one variant, the generative AI model executes entirely on the server, and the terminal functions mainly as an input/output interface. In another variant, a lightweight version of the model runs on the terminal for preliminary processing, such as local keyword extraction, to reduce network traffic and initial server load, while the main generation runs on the server. In yet another variant, the system uses a combination of a central server and edge servers, so that voice analysis is performed closer to the user's location to reduce latency while proposal generation remains centralized. The system can further vary in the choice of underlying database architecture, using a relational database, a document database, or a hybrid, as long as the data structures support indexed retrieval based on need and constraint fields. The terminal may be implemented as a smartphone, a tablet, or a personal computer. The terminal executes a client program that renders user interfaces for prompt input, proposal viewing, and guidance reception. The terminal manages local caches of frequently used product summaries or language resources to reduce repeated data transfer. By caching high-level representations or templates, the terminal can display preliminary proposals quickly while the server finishes more detailed generation in the background, thereby improving perceived responsiveness.

The user interacts with the system by entering prompt sentences, reviewing generated proposals, and following guidance. However, the essential improvements lie in the internal computer processing performed by the server and the terminal, including structured data management, advanced natural language understanding, neural generation conditioned on structured and behavioral features, and real-time signal processing. By designing the system such that these components operate in a coordinated, non-conventional manner-specifically, by combining prompt-based condition extraction, constrained neural proposal generation, integrated voice-based psychological state feedback, automatic follow-up content computation, and multilingual consistency—the invention provides a technical solution that enhances the functioning of the computing system itself, rather than merely automating a human business process.

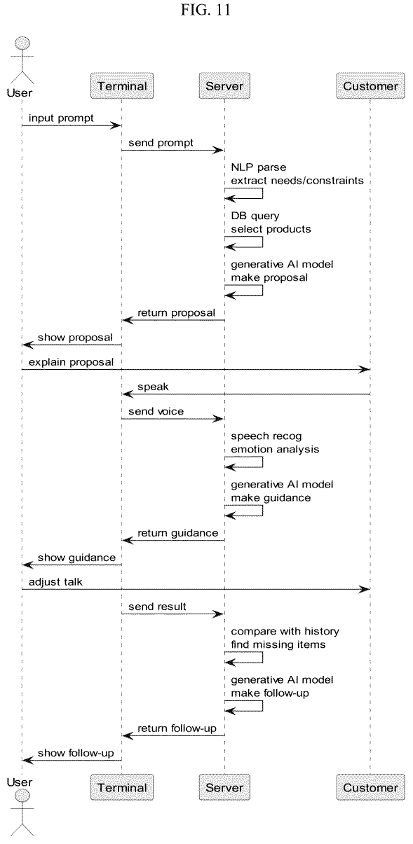

The following describes the processing flow using FIG. 11.

### Step 1:

The server initializes data structures and loads models.

The server loads product information, price information, usage information, and evaluation information from persistent storage into a database management system. As input, the server uses raw data files or existing database records. The server creates or updates database tables and indexes, and stores each product as a record with fields for identifiers, attributes, and relations. The output is a structured, indexed product data store that can be queried efficiently.

The server also loads a generative AI model and auxiliary neural network models (intent classifier, named entity recognizer, speech recognizer, emotion classifier) into memory using a machine learning framework. As input, the server uses trained model parameter files. The server allocates tensors, restores weights, and prepares tokenizers and preprocessing pipelines. The output is a set of model instances ready to process runtime requests.

### Step 2:

The user inputs a prompt sentence via the terminal.

The user views a text input field on a user interface rendered by the terminal and types a prompt sentence describing customer needs, for example, “Please generate an optimal proposal for a customer who is looking for environmentally friendly products.” As input, the user provides characters via a keyboard or touch interface. The terminal collects these characters, assembles them into a text string, and displays the text for confirmation. The output is a completed prompt sentence in text form held in the terminal's memory.

### Step 3:

The terminal sends the prompt sentence to the server.

The terminal takes the prompt sentence as input, packages it into a request message including metadata such as user ID, session ID, and timestamp, and encodes the message in a communication format such as JSON over HTTP or WebSocket. The terminal then transmits the request through a network interface to a predetermined server endpoint. The output is a network packet sequence carrying the prompt sentence to the server.

### Step 4:

The server performs natural language preprocessing on the prompt sentence.

The server receives the request as input through the network interface and extracts the prompt sentence string. The server applies a tokenizer to split the text into tokens, performs part-of-speech tagging, and runs a dependency parser to identify syntactic relations. The server computes vector embeddings using a transformer encoder to represent words and the entire sentence numerically. The output is a structured representation of the prompt sentence, including token list, syntactic structure, and embedding vectors.

### Step 5:

The server extracts customer need information and constraint condition information.

The server takes the structured representation from Step 4 as input and runs an intent classification model to determine categories such as “environmental preference,” “budget constraint,” and “quantity requirement.” The server executes a named entity recognition model to detect entities such as numbers, currencies, product categories, and adjectives describing product qualities. The server aggregates detected intents and entities into normalized fields, for example, a budget field with numeric lower and upper bounds, a feature field with flags for “environmentally friendly,” and a priority field indicating importance. The output is customer need information and constraint condition information expressed as structured records.

### Step 6:

The server formulates and executes database queries to retrieve candidate products.

The server receives customer need information and constraint condition information as input and constructs one or more database queries. The server maps need fields to column conditions, such as category=“office equipment,” environmental_flag=true, and price<=budget_limit. The server includes ORDER BY clauses based on relevance criteria such as rating and price proximity. The database engine executes these queries using indexes and returns matching rows. The server may perform additional filtering or ranking, such as discarding products with ratings below a threshold. The output is a prioritized list of candidate product records, each including identifiers and key attributes.

### Step 7:

The server prepares context data for the generative AI model.

The server takes the candidate product records and the customer need information as input and converts them into a text-based context string. The server formats information such as product names, key features, prices, and usage scenarios into a structured prompt template, and appends instructions indicating that a personalized sales proposal should be generated.

The server then tokenizes this combined text into model input tokens. The output is a sequence of tokens representing both structured product context and customer needs, ready to be processed by the generative AI model.

### Step 8:

The server generates a personalized proposal sentence using the generative AI model.

The server supplies the token sequence from Step 7 as input to a transformer-based generative AI model running on a CPU or GPU. The model processes the tokens through multiple layers of self-attention and feed-forward networks to compute hidden states. At each generation step, the server computes a probability distribution over possible next tokens, applies constraints (for example, disallowing tokens that contradict known prices), and selects one or more candidate tokens using a decoding strategy such as beam search or nucleus sampling. The server repeats this process until an end-of-sequence token appears or a length limit is reached. The output is a natural language proposal sentence or multi-sentence proposal text tailored to the customer needs.

### Step 9:

The server returns the proposal sentence to the terminal.

The server takes the generated proposal text as input and encapsulates it in a response message, optionally adding structured annotations such as product IDs and section labels. The server serializes the message into a network-friendly format and sends it back to the terminal via the network interface. The output is a network response packet containing the personalized proposal sentence.

### Step 10:

The terminal presents the proposal to the user.

The terminal receives the response from the server as input, parses the message, and extracts the proposal text and any associated metadata. The terminal renders the proposal on the display device, for example as headings, bullet points, and explanatory paragraphs. If audio output is enabled, the terminal passes the text to a text-to-speech engine, which synthesizes speech and outputs it through the speaker. The output is a visual and/or audio presentation of the proposal accessible to the user.

### Step 11:

The user explains the proposal to the customer.

The user reads the proposal displayed on the terminal as input and verbally explains product features, prices, and benefits to the customer, possibly following suggested talking points. The user may scroll through the proposal or highlight specific sections using touch or mouse input on the terminal. The output is a live sales conversation in which the customer hears the explanation and may respond with questions or comments.

### Step 12:

The terminal captures the customer's voice during the conversation.

The terminal uses the microphone as input hardware to capture acoustic signals produced by the customer. The terminal converts these analog signals into digital samples using an analog-to-digital converter, segments the audio into frames, and optionally compresses the data using an audio codec. The terminal timestamps the audio segments and buffers them locally. The output is digital voice data segments representing customer speech.

### Step 13:

The terminal sends the voice data to the server.

The terminal takes buffered voice data segments as input, packages them into one or more transmission units, and sends them to the server via a streaming protocol or batched HTTP requests. The terminal may include associated metadata such as segment order, language setting, and session identifiers. The output is a stream or series of network packets containing voice data for server-side analysis.

### Step 14:

The server performs speech recognition on the received voice data.

The server receives the voice data segments as input and passes them to a speech recognition pipeline. The server extracts acoustic features such as Mel-frequency cepstral coefficients and log-mel spectrograms from the raw audio samples. The server feeds these features into an acoustic model, such as a convolutional or transformer-based network, and decodes the output probabilities with a language model to produce text corresponding to the customer's utterances. The output is a time-stamped transcript of the customer's speech.

### Step 15:

The server computes acoustic features and estimates psychological state information.

The server takes the same voice data and the recognized text from Step 14 as input. The server computes additional acoustic features, including pitch statistics, intensity contours, speaking speed, and pause durations, by analyzing the waveform and timing information. The server segments the conversation into analysis windows and aggregates features per window.

The server feeds the feature vectors and corresponding text embeddings into a psychological state classification model, which outputs probabilities for states such as “interested,” “hesitant,” or “confused.” The server selects the most probable state for each window and optionally smooths the states over time. The output is psychological state information describing the customer's inferred emotional and engagement status.

### Step 16:

The server generates guidance or a revised proposal based on psychological state and context.

The server receives psychological state information, recognized customer utterances, and the current proposal content as input. The server forms a context text describing the negotiation phase, key customer remarks, and symbolic tags representing psychological states. The server tokenizes this context and provides it to the generative AI model with an instruction to produce either a guidance sentence for the user or a revised version of the proposal. The model processes this input in a similar manner as in Step 8, generating text that recommends response strategies or adjusts product emphasis. The output is a guidance sentence and/or a revised proposal sentence tuned to the customer's current state.

### Step 17:

The server sends the guidance or revised proposal to the terminal.

The server takes the generated guidance and revised proposal as input, embeds them in a response message with flags indicating that the content is for internal user guidance, and transmits the message to the terminal. The output is a network response that delivers adaptive support information to the terminal in near real time.

### Step 18:

The terminal presents guidance to the user during the negotiation.

The terminal receives the guidance content as input, parses the message, and displays the guidance sentence in a user-only area of the screen, such as a sidebar or overlay not visible to the customer. The terminal may use visual emphasis, such as color or icons, to indicate urgency or importance. The user reads this guidance concurrently with the ongoing conversation. The output is a real-time advisory display that assists the user in adjusting explanation content and tone.

### Step 19:

The user adjusts the explanation based on the guidance.

The user takes the guidance sentence and any revised proposal text as input and modifies the spoken explanation accordingly. The user may emphasize particular benefits, address identified concerns, or change the recommended product configuration, while continuing to use the terminal to reference details. The output is an updated sales conversation that is responsive to the customer's inferred psychological state.

### Step 20:

The server records business negotiation result information.

The server receives, as input, explicit signals from the terminal or user (such as confirmation of purchased items or negotiation outcome) and implicit data such as final proposal versions and customer responses. The server stores this information in structured form, recording items such as accepted products, rejected products, objections, and final decisions. The server associates this result information with the corresponding customer profile and session ID in the database. The output is a persistent record of negotiation results available for later analysis.

### Step 21:

The server compares negotiation results with history information of existing purchasers.

The server takes the negotiation result information and prior purchaser history from the information storage unit as input. The server computes similarity between the current customer and past customers using attributes such as industry, size, and purchased product sets. The server identifies product categories or features that are commonly selected by similar customers but absent from the current purchase set. The server marks these as candidate additions for follow-up proposals. The output is a list of missing product categories, functions, or service conditions relevant to the current customer.

### Step 22:

The server generates follow-up proposal content using the generative AI model.

The server receives the list of missing items and contextual information about the negotiation as input. The server constructs a follow-up context text describing what was purchased, what is missing, and how similar customers typically benefit from the missing items. The server tokenizes this text and provides it to the generative AI model with an instruction to generate a follow-up proposal sentence, a proposal document structure, or a proposal video script. The model generates structured and unstructured text that recommends additional products or services and organizes them into sections or scenes. The output is follow-up proposal content ready to be delivered to the terminal.

### Step 23:

The terminal receives and stores follow-up proposal content for later use.

The terminal takes the follow-up content sent by the server as input, displays a notification to the user, and stores the content in local storage or a user-accessible list. The user can later select and use this content for follow-up communication with the customer. The output is a set of accessible follow-up proposals that extend the original negotiation.

### Step 24:

The server performs multilingual processing when needed.

The server takes, as input, the prompt sentence, proposal sentences, guidance sentences, and recognized customer utterance text, along with language settings or detected language tags.

The server uses a machine translation model to convert texts between a base language and target languages. The server ensures that internal processing, including need extraction and proposal generation, can be executed in a consistent base representation, and that only input and output boundaries are translated. The output is language-converted texts that preserve the underlying proposal logic while allowing users and customers to interact in their preferred languages.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented sales support systems typically focus on static recommendation logic, such as rule-based matching or simple collaborative filtering, that operates on pre-defined customer attributes. Such systems generally assume that customer input is already available as structured data, or as clean text entered through a form or a simple chat interface. As a result, these systems are not well suited to real-time, in-person sales environments in which the primary interaction modality is spontaneous spoken conversation, and in which the customer's psychological state dynamically changes during the interaction.

In particular, in existing systems, the computing infrastructure is not configured to continuously capture mixed conversational audio from multiple speakers, to reliably separate the customer's utterances from staff utterances, and to convert those utterances into structured intent information in a form that can be used to drive downstream processing. Existing systems also lack an integrated mechanism for combining acoustic emotion analysis and textual sentiment analysis to estimate a fine-grained psychological state of the customer and to use that state as a first-class input for subsequent computation.

Furthermore, conventional recommendation engines are not architected to generate machine-readable prompt sentences for a generative AI model that explicitly encode both structured customer requirements and estimated psychological state. As such, the underlying computing system cannot systematically control the output tone, explanation style, and level of detail of the generated content in response to real-time conversational signals. Instead, generative models are often invoked with ad-hoc, manually crafted prompts, leading to inconsistent response quality and limited ability to scale across many simultaneous sessions.

In addition, many existing systems merely return natural-language recommendations without considering how those recommendations will be rendered within constrained visual interfaces such as head-mounted displays. They do not generate display structure data optimized for low-latency updates, limited display area, or hands-free operation, nor do they maintain persistent, machine-usable logs that link audio, text, intent, psychological state, and generated content for continuous system improvement.

From a computer technology perspective, there is a need for a system architecture and processing pipeline that: (i) transforms raw conversational audio into structured representations of intent and psychological state; (ii) translates those representations into structured prompt sentences for a generative AI model; (iii) uses the generative AI model as a component within a deterministic control loop, rather than as an isolated black box; and (iv) produces structured display data tailored to wearable visual devices, while logging all intermediate representations for machine learning-based refinement. Without such an architecture, computer systems cannot efficiently support a small number of human operators in simultaneously handling a large number of customers with personalized, context-aware, and emotionally appropriate proposals in real time.

The specific processing by the specific processing unit 290 of the data processing device 12 in Application Example 1 is realized by the following means.

The present invention provides a server comprising a processor configured to acquire conversational audio data from a remote terminal, divide the conversational audio data into audio segments in a predetermined audio format, and transmit or receive the audio segments via a communication path; to perform speech recognition processing on the conversational audio data to generate character information, and to perform natural language processing including speaker discrimination processing and intent extraction processing on the character information so as to obtain customer request information as structured information; to extract acoustic feature information based on the conversational audio data, to extract emotion information based on the character information, and to estimate customer psychological state information based on the acoustic feature information and the emotion information; to search an information storage apparatus storing merchandise information including merchandise attribute information, price information, usage information, and evaluation information, to acquire candidate merchandise information in accordance with the customer request information and the customer psychological state information, and to perform suitability evaluation and ranking on the candidate merchandise information; to construct a prompt sentence for a generative AI model based on the customer request information, the customer psychological state information, and the candidate merchandise information, and to include, in the prompt sentence, an output tone and an explanation style corresponding to the customer psychological state; to input the prompt sentence and the candidate merchandise information to the generative AI model, to cause the generative AI model to generate response information including personalized merchandise proposal information, and to convert the response information into display structure data suitable for a visual information display device; and to record, in association with one another, the conversational audio data, the character information, the customer request information, the customer psychological state information, and the merchandise proposal information, and to generate learning data for updating at least the intent extraction processing, the psychological state estimation, and a configuration method of the prompt sentence based on the record. This enables a computer system to implement an integrated, closed-loop processing pipeline that converts raw multi-speaker conversational audio into structured intent and psychological state representations, uses those representations to programmatically control a generative AI model via dynamically constructed prompt sentences, generates structured display data optimized for real-time presentation on wearable visual devices, and continuously refines the underlying models and prompt configuration based on logged interaction data, thereby improving the technical performance, scalability, and adaptivity of computer-implemented sales support in real-world conversational environments.

The term “conversational audio data” refers to audio information representing spoken dialogue between at least a customer and an operator, including mixed speech from multiple speakers captured during an interactive session.

The term “audio segment” refers to a unit portion of conversational audio data obtained by dividing a continuous audio stream into smaller time-based blocks in a predetermined audio format for processing or transmission.

The term “communication path” refers to a logical or physical communication channel, such as a wired or wireless network connection, through which data including audio segments and control messages is transmitted between a terminal and a server.

The term “speech recognition processing” refers to computational processing that converts audio data representing spoken language into corresponding character information in a machine-readable text format.

The term “character information” refers to text data generated by speech recognition processing that represents recognized linguistic content of spoken utterances.

The term “natural language processing” refers to computational processing that analyzes character information in a human language to derive structured information such as speaker identity, intent, entities, and semantic relationships.

The term “speaker discrimination processing” refers to processing that distinguishes and labels different speakers within conversational audio data or related character information, such as classifying utterances as belonging to a customer or an operator.

The term “intent extraction processing” refers to processing that identifies and structures the underlying purpose, request, or objective expressed in character information, such as determining a product category, constraints, and desired features.

The term “customer request information” refers to structured information describing a customer's needs, preferences, and constraints derived from conversational audio data and character information through intent extraction processing.

The term “structured information” refers to information represented in a defined data format, such as key-value pairs, records, or hierarchical data, that enables programmatic access and manipulation by a computing system.

The term “acoustic feature information” refers to numerical or symbolic features extracted from audio data, including but not limited to pitch, energy, spectral characteristics, timing, and prosodic patterns, used for analysis of emotion or speaker state.

The term “emotion information” refers to information indicating an inferred emotional content or sentiment derived from character information or audio data, such as calmness, anxiety, confidence, or hesitation.

The term “customer psychological state information” refers to information that represents an estimated mental or emotional condition of a customer, calculated by combining acoustic feature information and emotion information and optionally other contextual data.

The term “information storage apparatus” refers to a hardware and software combination that stores data for access by a processor, such as a database system, storage device, or memory subsystem.

The term “merchandise information” refers to information describing one or more items or services to be recommended or sold, including merchandise attribute information, price information, usage information, and evaluation information.

The term “merchandise attribute information” refers to descriptive properties of merchandise, such as type, specifications, functions, capabilities, or technical characteristics.

The term “price information” refers to information indicating a monetary amount or pricing condition associated with merchandise, such as base price, discount, or price range.

The term “usage information” refers to information describing typical use cases, usage environments, operating methods, or application scenarios of merchandise.

The term “evaluation information” refers to information indicating assessments or ratings of merchandise, such as review scores, qualitative feedback, popularity indicators, or performance evaluations.

The term “candidate merchandise information” refers to a subset of merchandise information selected based on conditions including customer request information and customer psychological state information as potential recommendation targets.

The term “suitability evaluation” refers to processing that computes a degree of match between candidate merchandise information and customer request information and optionally customer psychological state information.

The term “ranking” refers to ordering candidate merchandise information according to a suitability evaluation or other scoring criteria to determine a priority or recommendation order.

The term “generative AI model” refers to a machine-learning-based computing model that generates new data, such as natural language text, in response to input information, including a prompt sentence and structured data.

The term “prompt sentence” refers to a machine-constructed natural-language or structured instruction string that conditions the behavior of a generative AI model by specifying context, constraints, objectives, and desired response style.

The term “output tone” refers to a desired stylistic characteristic of generated text, such as formality level, emotional coloring, or interpersonal stance, encoded as part of a prompt sentence.

The term “explanation style” refers to a desired presentation mode of generated information, including depth of detail, technicality, structure, and narrative form, encoded as part of a prompt sentence.

The term “response information” refers to information output by a generative AI model based on a prompt sentence and other input data, including at least natural-language content representing generated proposals or explanations.

The term “personalized merchandise proposal information” refers to response information that describes one or more merchandise options tailored to a specific customer's request information and psychological state information.

The term “display structure data” refers to data that organizes response information into a structured format suitable for rendering on a display, including segmentation, ordering, and formatting attributes for visual presentation.

The term “visual information display device” refers to a device capable of presenting information visually to a user, such as a head-mounted display, smart glasses, monitor, or other image display apparatus.

The term “operator” refers to a human user who interacts with the system to support sales or consultation, and who receives visual guidance from the visual information display device.

The term “reaction information” refers to information indicating a customer's response or behavior during a conversation, derived from conversational audio data, character information, or other interaction signals.

The term “operation information” refers to information indicating actions performed by an operator on a terminal or system interface, such as selection operations, navigation commands, or control inputs.

The term “follow-up prompt sentence” refers to a prompt sentence generated after an initial prompt sentence, based on reaction information or operation information, that instructs a generative AI model to produce additional or revised content.

The term “additional proposal information” refers to response information generated by a generative AI model in response to a follow-up prompt sentence, addressing additional requests, objections, or refinements from a customer.

The term “first natural language” refers to a natural language used as a source language for generated or stored textual information before a machine translation process.

The term “second natural language” refers to a natural language different from the first natural language, used as a target language for presenting textual information after a machine translation process.

The term “machine translation process” refers to computational processing that converts text from one natural language into another natural language using algorithmic or machine-learning-based translation techniques.

The term “multilingual support processing” refers to processing that enables the system to handle, generate, or display information in multiple natural languages, including by performing a machine translation process.

The term “learning data” refers to data prepared or collected for training, updating, or fine-tuning one or more models or algorithms, including intent extraction models, psychological state estimation models, and prompt configuration strategies.

The term “configuration method of the prompt sentence” refers to a rule set, algorithm, or model that determines how a prompt sentence is structured, including which elements are included, how they are ordered, and how they are phrased in response to input conditions.

The term “closed-loop processing pipeline” refers to a sequence of computational operations in which outputs, such as response information and logged data, are fed back into earlier stages, such as model training or prompt configuration, to continuously improve system behavior.

In one embodiment, a server, a terminal, and a user cooperate to implement the claimed system. The server comprises a hardware platform including at least one multi-core central processing unit (CPU), such as a general-purpose ×86 or ARM processor, volatile and non-volatile memory, a network interface controller, and optionally one or more graphics processing units (GPUs) optimized for matrix operations. The server executes system software including an operating system, such as a general-purpose server operating system, and middleware including a web application framework, a database management system, and one or more machine learning runtimes such as a tensor computation library.

The terminal comprises a wearable information processing device such as smart glasses or a head-mounted display, or a handheld communication device such as a smartphone or tablet. The terminal includes a microphone, an image display unit, a wireless communication module, and a local processor executing a client application. The user wears or holds the terminal and interacts with customers in a physical environment, such as a retail store.

The server stores, in a non-transitory storage apparatus, executable programs that implement modules for speech recognition, natural language processing, acoustic feature extraction, emotion estimation, psychological state estimation, database retrieval, ranking, prompt sentence construction, generative AI model inference, display data structuring, and learning data generation. The server also stores a product knowledge dataset in a database system. This dataset includes, for each item, attribute fields such as category, technical specifications, usage scenarios, price, and evaluation scores. The server manages indexes on these fields to allow efficient retrieval based on structured queries.

The server uses a speech recognition module that can be implemented, for example, as a deep neural network based on a sequence-to-sequence architecture, a connectionist temporal classification (CTC) architecture, or a transformer encoder-decoder. The server configures this module to accept audio waveforms encoded as 16-bit linear PCM at a predetermined sampling rate such as 16 kHz and to output character information encoded in a character set such as UTF-8. The server uses acoustic front-end processing to compute spectral features, such as Mel-frequency cepstral coefficients (MFCCs) or log Mel-spectrograms, and passes these features to the neural network model. By performing computation on GPUs using tensor operations, the server improves processing throughput and reduces latency relative to a purely CPU-based implementation.

The server uses a natural language processing module to transform the character information into structured information. In one configuration, the server uses a transformer-based language model encoder that has been fine-tuned as an intent classifier. The server defines a schema for customer request information that includes fields such as product category, budget range, primary feature preferences, and any explicit constraints. The server feeds tokenized text into the encoder, obtains contextual embeddings, and applies one or more classification layers with softmax outputs to assign probabilities over predefined intent labels and slot values. The server then constructs a structured representation, such as a record with key-value pairs in memory, representing customer request information.

The server further uses a speaker discrimination module. In one embodiment, the server uses a diarization model that extracts speaker embeddings (for example, x-vectors or other embedding vectors) from short windows of the audio signal and clusters those embeddings to assign speaker identities. The server correlates the speaker segments with the timing of the character information produced by the speech recognition module. By this processing, the server separates text segments spoken by the customer from text segments spoken by the user. This separation improves downstream intent extraction because the server can restrict intent analysis to customer utterances.

The server uses an acoustic feature extraction module to compute acoustic feature information indicative of prosody, such as pitch, energy, speaking rate, and pause distribution. The server computes these features on short, overlapping frames of the audio signal and aggregates statistics over larger windows corresponding to utterances. The server passes these aggregated features to an emotion estimation model such as a convolutional neural network or recurrent neural network trained on labeled emotional speech corpora. The server also applies a text-based sentiment analysis model, such as a transformer-based classifier fine-tuned on sentiment labels, to the character information. By combining the acoustic emotion prediction and text sentiment prediction using a fusion algorithm, such as a weighted averaging or a small feed-forward network that takes both predictions as input, the server estimates customer psychological state information. This information may take the form of categorical labels (for example, calm, hesitant, excited) and continuous scores indicating intensity and confidence.

The server stores the customer psychological state information in association with the customer request information and the current conversation context. The server then executes a database retrieval module that issues queries to the product knowledge database. These queries include constraints derived from both the customer request information and the psychological state information. For example, if the psychological state indicates high price sensitivity, the server may restrict the price range or increase the weight of price-related ranking features. The server retrieves candidate merchandise information that satisfies the constraints and passes this information to a ranking module.

The server implements the ranking module using a machine learning model such as a gradient boosting decision tree, a linear model, or a neural network. The server constructs feature vectors for each candidate item that include product attributes, price-related metrics, popularity metrics, and similarity metrics between the product attributes and the inferred customer preferences. The server computes a suitability score for each candidate and sorts the candidates accordingly. By executing this ranking with precomputed indices and model weights loaded in memory, the server reduces the time required to select the top items, thereby enabling low-latency responses even with large product catalogs.

The server then constructs a prompt sentence to control a generative AI model. The server uses a prompt construction module that follows a deterministic template structure. The template includes sections for session summary, customer request information, customer psychological state information, ranked candidate merchandise information, and explicit instructions on style and tone. The server maps the structured fields into natural-language phrases using rule-based templates, ensuring consistent phrasing and ordering. By contrasts with ad-hoc, manually written prompts, this rule-based, data-driven construction enables the server to generate prompt sentences that are systematically aligned with the current context. In one example, the server constructs a prompt sentence in the following form:

“The customer is looking for a new smartphone with a very good camera but a moderate price. Here is the list of candidate products with their main specifications, prices, and review scores: [PRODUCT_LIST]. Analyze these candidates and propose 2-3 models that offer the best balance of camera quality and price for an everyday user, and explain the reasons in simple terms that a non-expert can understand. The customer sounds slightly hesitant, so use a reassuring and friendly tone.”

In another example, the server constructs a follow-up prompt sentence such as:

“The customer says that the first recommended model is too expensive and prefers a lower price. From the current candidate products and any additional products under the new budget, propose alternative models under the revised price limit, and clearly explain the main trade-offs in camera performance and battery life. Continue to use a polite and reassuring tone.”

The server uses a generative AI model that can be implemented, for example, as a large transformer-based language model trained on a mixture of general text data and domain-specific data. The server loads model parameters into GPU memory to accelerate inference.

The server supplies the prompt sentence and a compact representation of the candidate merchandise information to the generative AI model. The server sets inference parameters such as a maximum token length, a temperature parameter, and a top-k or top-p sampling parameter to control output variability. The generative AI model computes, at each decoding step, a probability distribution over vocabulary tokens based on the current hidden state and the attention mechanism applied to the prompt context, and then selects tokens according to the configured sampling scheme until an end-of-sequence condition is met.

The server receives the response information from the generative AI model and passes it to a post-processing module. This module parses the response into logical segments, such as main recommendation, alternatives, and key selling points, based on cue phrases or explicit markers that may be inserted into the prompt sentence. The server then constructs display structure data that encodes, for each segment, its type, priority, and display constraints like maximum character length. The server uses a layout algorithm that considers the limited size and resolution of the terminal's display and organizes the content into concise cards or bullet lists. By pre-structuring the display data, the server reduces rendering complexity at the terminal and ensures that only the most relevant information is transmitted.

The terminal receives the display structure data via a wireless communication module and renders it on the image display unit. The terminal runs a client application that interprets the structure data and draws overlay elements on the display surface, such as product names, prices, and short textual cues. The user perceives these overlays while maintaining visual contact with the customer. Because the server supplies compact, structured payloads and because the terminal avoids heavy computation, the communication load and rendering time are reduced. This configuration improves responsiveness and prevents lag that could otherwise disrupt in-person conversation.

The server also records, in a log storage subsystem, the conversational audio data, the character information, the customer request information, the psychological state information, the candidate merchandise information, the constructed prompt sentences, and the generated merchandise proposal information, in association with session identifiers and timestamps.

The server uses this logged data as learning data to refine the intent extraction models, the psychological state estimation models, and the prompt configuration rules. For example, the server can perform supervised learning where annotated sessions indicate which recommended items led to successful outcomes. The server can compute a loss function based on prediction errors for intent or emotion, or based on misalignment between generated recommendations and selected purchases, and can update model weights using gradient descent. The server may apply data augmentation techniques such as paraphrasing, time-stretching of audio, or noise injection to increase robustness.

The described configuration improves computer technology in several ways. By integrating diarization, acoustic feature extraction, and emotion fusion, the server achieves more accurate separation of speakers and more reliable psychological state estimation than prior systems that rely solely on text-based sentiment. This improved estimation, in turn, allows the server to select and weight candidate merchandise information in a way that reduces misalignment between recommendations and customer needs. The structured prompt construction mechanism transforms the generative AI model from a loosely controlled text generator into a component of a deterministic processing pipeline: the server converts structured state into a prompt sentence according to formalized rules, thereby reducing variance in output quality and making the processing more predictable and testable.

Furthermore, by converting the raw generative output into display structure data that is tailored to the terminal's display constraints, the server reduces transmission size and local rendering workload. As a result, latency is lowered and the system can support a larger number of concurrent sessions without degradation. In contrast to approaches that send full unstructured text streams for rendering on the client, this design shifts the structuring workload to the server side, where more powerful hardware is available, and only sends the minimal required representation.

The server also implements non-conventional feedback and training loops. The server does not simply log the final recommendations; instead, the server logs intermediate internal representations—such as acoustic features, intent vectors, and psychological state vectors—and uses them to refine the models and prompt rules. This multi-level logging and feedback structure enables the server to reduce error rates over time, for example by decreasing the misclassification rate of customer intent or by increasing accuracy in psychological state estimation.

The system is not limited to a single generative AI model or a single architecture. In one variation, the server uses a smaller, domain-specific generative AI model deployed on-premises for privacy, while in another variation the server uses a larger, remotely hosted generative AI model accessible via an application programming interface. In yet another variation, the server uses an ensemble of models, where one model generates the main explanation and another model checks for completeness or policy compliance. The server can also vary the structure of the prompt sentence based on the type of terminal, such as a larger prompt for a desktop terminal and a shorter prompt for an embedded device.

The terminal and the server can also vary in configuration. In one embodiment, the terminal is implemented as smart glasses with a see-through display and a low-power processor, and the server offloads most computation. In another embodiment, the terminal is a handheld device that performs speech recognition locally using a compact on-device model, and the server focuses on higher-level processing such as database retrieval, ranking, and generative AI inference. In both cases, the data structures and processing modules described above remain substantially the same, but the allocation of computation across server and terminal may change.

The user interacts with the system in a manner that leverages these technical improvements. The user observes concise, context-aware prompts and explanations that are updated with low latency as the conversation proceeds. Because the system integrates real-time speech processing, psychological state estimation, structured ranking, prompt sentence construction, and generative AI control in a closed-loop architecture, the user can rely on the system for dynamic, high-quality guidance that could not be feasibly produced using conventional rule-based or static recommendation mechanisms alone.

By combining specific data structures, hardware configurations, neural network architectures, prompt construction rules, and optimized data flows from acquisition to display, the system achieves technical effects including reduced response time, reduced bandwidth usage, improved accuracy of intent and emotion estimation, and increased consistency of generative outputs. These effects improve the performance of the underlying computer system itself, rather than constituting mere automation of a human sales process.

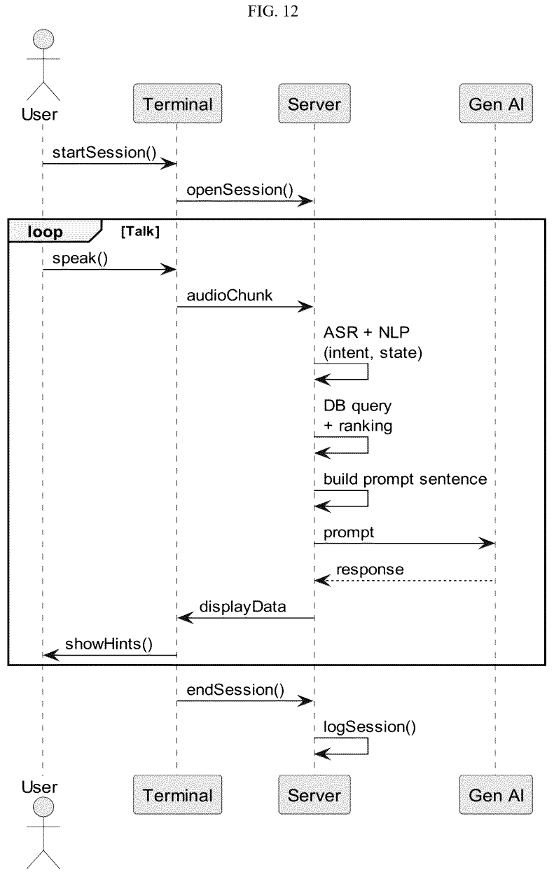

The following describes the processing flow using FIG. 12.

### Step 1:

The user activates the sales support mode on the terminal.

The user operates a graphical user interface or a voice command to start a new session. The input is a user action such as tapping a “Start session” button or issuing a spoken command. The output is a session start request message that the terminal prepares for transmission to the server.

### Step 2:

The terminal establishes a communication channel with the server.

The terminal initializes a wireless communication module and opens a secure network connection using a transport protocol such as HTTPS or WebSocket. The input is the session start request generated in Step 1 and network configuration information stored on the terminal. The output is an authenticated and encrypted communication channel associated with a unique session identifier received from the server.

### Step 3:

The terminal captures conversational audio data from the environment.

The terminal activates a microphone and records continuous audio including voices of the user and the customer. The input is analog sound waves in the physical environment. The terminal converts these into digital audio samples in a predetermined format, such as 16-bit linear PCM at 16 kHz. The output is a continuous digital audio stream buffered in memory.

### Step 4:

The terminal segments the audio stream into audio segments and transmits them to the server.

The terminal divides the buffered audio stream into time-based windows (for example, 2-5 seconds) and attaches metadata such as session ID, sequence number, and timestamp. The input is the continuous audio stream from Step 3. The terminal performs array slicing and framing operations to produce discrete audio segments. The output is a series of audio segments with associated metadata sent to the server over the established channel.

### Step 5:

The server receives and stores incoming audio segments.

The server listens on the communication channel and decodes received packets to reconstruct each audio segment. The input is the network packets containing audio payloads and metadata from the terminal. The server validates the session ID, checks sequence numbers, and writes the audio segments to a session-specific buffer in memory or temporary storage. The output is an ordered buffer of audio segments ready for further processing.

### Step 6:

The server performs speech recognition processing on the audio segments.

The server feeds each audio segment into a speech recognition engine implemented by a neural network model. The input is the digital audio samples from the buffer in Step 5. The server computes acoustic features such as log Mel-spectrograms, passes them through a trained sequence model (for example, a transformer-based acoustic model), and applies decoding (for example, beam search with a language model) to obtain recognized text. The output is character information representing transcriptions of each audio segment.

### Step 7:

The server aligns and aggregates recognized text into utterances.

The server combines the character information for successive segments into longer utterances based on timing information and pause detection. The input is the per-segment transcriptions and timestamps from Step 6. The server applies rules such as merging segments with short inter-segment gaps and splitting on long pauses or sentence boundary markers. The output is a list of utterance objects, each containing text, start time, and end time.

### Step 8:

The server performs speaker discrimination on the utterances.

The server uses a speaker diarization module to separate customer speech from user speech. The input is the audio segments and their corresponding utterances from Steps 5 and 7. The server extracts speaker embeddings from each audio segment, performs clustering or classification to assign speaker labels, and matches these labels with utterance time ranges. The output is a set of labeled utterances, where each utterance is tagged as “customer” or “user.”

### Step 9:

The server executes intent extraction on customer utterances.

The server applies a natural language processing model to detect the customer's needs and constraints. The input is the text of utterances labeled as “customer” from Step 8. The server tokenizes the text, encodes it with a transformer encoder, and passes the embeddings through classification and slot-filling layers to identify product category, budget, and feature preferences. The output is customer request information structured as a data record with fields such as category, budget range, and desired features.

### Step 10:

The server extracts acoustic feature information from the audio segments.

The server computes acoustic descriptors that capture prosody and speaking style. The input is the raw audio segments associated with customer utterances. The server performs frame-level signal processing to calculate pitch, energy, formant-related features, and temporal features such as speech rate and pause durations, then aggregates statistics for each utterance. The output is acoustic feature vectors representing the prosodic profile of the customer's speech.

### Step 11:

The server computes emotion information from text and audio.

The server estimates emotional cues using both textual and acoustic signals. The input is the character information of customer utterances from Step 7 and the acoustic feature vectors from Step 10. The server applies a text sentiment classifier to the text and an emotion classification neural network to the acoustic features. The server then combines the outputs by applying a fusion function, such as a weighted sum or a small fully connected network, to generate emotion probabilities. The output is emotion information that includes predicted emotion categories and confidence scores.

### Step 12:

The server estimates customer psychological state information.

The server integrates emotion information and conversation context to produce a higher-level psychological state. The input is the emotion information from Step 11 and the current customer request information and history stored in session context. The server applies a rule-based mechanism or a learned mapping function to convert low-level emotions into a psychological state label and continuous scores indicating factors such as price sensitivity or indecision. The output is customer psychological state information registered in the session context.

### Step 13:

The server retrieves candidate merchandise information from the product database.

The server queries a database management system to find relevant items. The input is the customer request information and psychological state information from Steps 9 and 12. The server generates a database query using constraints on category, price range, and key attributes, and uses indices to efficiently retrieve matching records. The output is candidate merchandise information, which is a list of products with associated attribute, price, usage, and evaluation fields.

### Step 14:

The server evaluates suitability and ranks candidate merchandise information.

The server computes a suitability score for each candidate using a ranking model. The input is the candidate merchandise information from Step 13 and customer-related features derived from request and psychological state data. The server constructs feature vectors and evaluates a trained ranking function such as a gradient boosting model to obtain a score per candidate.

The server then sorts the candidates by score. The output is a ranked list of candidate merchandise information.

### Step 15:

The server summarizes key attributes of top-ranked candidates.

The server converts raw database fields into concise descriptions for display and for inclusion in a prompt. The input is the top portion of the ranked list from Step 14. The server applies text templates and rule-based summarization to generate short phrases that highlight key features, price points, and advantages. The output is a summarized candidate list, where each item includes a short name, a price, and key selling points.

### Step 16:

The server constructs a base prompt sentence for a generative AI model.

The server builds a structured natural-language instruction that encodes the current session state. The input is the customer request information, psychological state information, and summarized candidate list from Steps 9, 12, and 15. The server fills a predefined template by inserting description of the customer's needs, a description of the psychological state, and a serialized representation of candidate products. The output is a base prompt sentence that instructs the generative AI model on the desired content and style.

### Step 17:

The server adjusts the prompt sentence to control output tone and explanation style.

The server modifies specific sections of the base prompt sentence according to the psychological state. The input is the base prompt sentence from Step 16 and the psychological state information from Step 12. The server applies rules such as adding phrases like “use a reassuring and friendly tone” or “provide a concise technical explanation” depending on the psychological state. The output is a finalized prompt sentence that explicitly encodes tone and style requirements.

### Step 18:

The server invokes the generative AI model with the prompt sentence and candidate data.

The server sends the finalized prompt and structured candidate information to a generative AI inference engine running locally or accessed via an API. The input is the prompt sentence from Step 17 and the summarized candidate list from Step 15. The server prepares a model input sequence, encodes the candidate data into a textual or tokenized form, and calls the generative AI model with specified decoding parameters. The output is response information, typically a natural-language explanation including recommended products and reasoning.

### Step 19:

The server parses and structures the response information.

The server transforms the raw generated text into structured segments for display. The input is the response information from Step 18. The server scans for section delimiters or uses pattern matching to identify main recommendations, alternative options, and bullet points.

The server then constructs display structure data that associates each segment with metadata such as segment type, priority, and maximum display length. The output is structured display data suitable for rendering on the terminal.

### Step 20:

The server transmits the display structure data to the terminal.

The server packages the structured display data with session identifiers and sequence numbers and sends it through the existing communication channel. The input is the display structure data from Step 19. The server performs serialization into a compact format and writes it to the network socket. The output is a stream of update messages delivered to the terminal.

### Step 21:

The terminal receives and renders the display structure data.

The terminal decodes incoming messages and updates the visual interface accordingly. The input is the update messages containing display structure data from Step 20. The terminal parses the structure, maps segments to user interface components such as text overlays or panels, and issues drawing commands to the display hardware. The output is a visual presentation showing recommended products, key features, and suggested talking points to the user.

### Step 22:

The user references the displayed information during the conversation.

The user glances at the terminal's display to obtain guidance while speaking to the customer. The input is the visual information presented by the terminal in Step 21. The user incorporates the suggested phrases and product information into natural speech directed to the customer. The output is an updated verbal explanation to the customer that reflects the system's recommendations.

### Step 23:

The terminal captures follow-up conversational audio and interaction signals.

The terminal continues recording audio and may also detect simple user input such as touch gestures or button presses indicating navigation or requests for more detail. The input is ongoing sound in the environment and physical user actions. The terminal converts the audio to additional audio segments and encodes the interaction events as control messages. The output is updated audio segments and interaction data sent to the server.

### Step 24:

The server generates follow-up prompt sentences based on reactions and operations.

The server updates the conversation context using new audio and interaction information. The input is the new labeled customer utterances from repeated processing of Steps 6-12 and the operation information from the terminal in Step 23. The server analyzes whether the customer raised objections or additional requests, then constructs a follow-up prompt sentence that describes these new conditions and asks the generative AI model for adjusted recommendations or clarifications. The output is one or more follow-up prompt sentences tailored to the new situation.

### Step 25:

The server obtains additional proposal information from the generative AI model.

The server sends the follow-up prompt sentences and updated candidate data to the generative AI model. The input is the follow-up prompt sentences from Step 24 and any modified candidate merchandise information. The server repeats the inference and parsing process similar to Steps 18 and 19 to produce new response information. The output is additional proposal information that addresses the customer's latest reactions, structured again as display data.

### Step 26:

The server logs multimodal session data for learning.

The server records key intermediate and final data associated with the session for later training and optimization. The input is the conversational audio data, character information, customer request information, psychological state information, candidate merchandise information, prompt sentences, and merchandise proposal information generated across Steps 5-25. The server writes this data, linked by session IDs and timestamps, to a persistent storage subsystem. The output is a comprehensive session log that can be used as learning data to retrain or fine-tune models and to adjust prompt construction rules.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented support systems for negotiations and customer interactions typically rely on static rule sets, manually crafted scripts, or simple keyword-based analysis. Such systems are unable to dynamically interpret subtle variations in a counterpart's psychological state from voice data, and therefore cannot generate appropriately tailored guidance in real time. Moreover, existing architectures usually treat audio preprocessing, acoustic feature extraction, psychological state estimation, and generation of negotiation guidance as separate modules, without a unified control mechanism that can flexibly instruct advanced generative AI models. As a result, large computational models are often underutilized, misconfigured, or applied in ways that produce inconsistent or suboptimal advice.

In addition, most current systems do not provide a standardized way for a processor to construct and issue structured prompt sentences that coordinate multiple stages of processing, such as receiving audio from a terminal, performing noise reduction and volume normalization, extracting acoustic features, feeding such features into a generative AI model, and combining the resulting psychological analysis with user-entered prompt sentences and domain-specific knowledge. This lack of an integrated prompt orchestration mechanism limits the ability of generative AI models to improve computer performance for negotiation support, including responsiveness, stability of output quality, and scalability for handling many parallel interactions.

Further, when historical successful case data and multilingual environments are involved, conventional systems frequently require manual tuning and ad hoc configuration to compare current psychological states with past cases and to translate guidance content into appropriate languages. This increases development complexity, introduces latency, and reduces reliability. There is therefore a need for a computerized technique that improves how processors orchestrate generative AI models through programmatically generated prompt sentences, thereby enhancing the overall technical performance of negotiation support systems in terms of automation, accuracy, adaptability, and multilingual presentation.

The specific processing by the specific processing unit 290 of the data processing device 12 in Example 2 is realized by the following means.

The present invention provides a server comprising a processor configured to generate, for a generative AI model, structured prompt sentences that instruct automation of operational procedures for information provision or transaction activities, reception and preprocessing of voice data including noise reduction and volume normalization, extraction of acoustic feature values including tone, volume, speaking speed, and speech pattern from the preprocessed voice data, estimation of a psychological state of a counterpart by inputting the acoustic feature values to the generative AI model based on learning data, and generation and output of guidance information including a negotiation policy or response policy on the basis of the estimated psychological state, domain-specific knowledge, and a user-entered prompt sentence. This enables a computer-implemented system to technically improve negotiation support by centrally orchestrating complex audio analysis and generative AI inference through standardized prompt sentences, thereby increasing processing efficiency, enhancing robustness and consistency of generated guidance, and facilitating scalable and multilingual deployment.

The term “system” refers to an arrangement of one or more computing devices, storage resources, and communication interfaces that cooperate to execute programmed operations as described in the claims.

The term “processor” refers to a hardware processing unit, such as a central processing unit or a processing core, that executes machine-readable instructions to perform computational operations and control functions.

The term “generative AI model” refers to a machine learning model, such as a neural network or transformer-based model, that is configured to generate output data, including text or other content, in response to input data, based on patterns learned from training data.

The term “prompt sentence” refers to a structured text or data string provided to a generative AI model to specify a task, constraint, or instruction that guides the model's subsequent processing and output generation.

The term “operational procedure” refers to a sequence of computer-implemented steps or workflows used to perform information provision, transaction activities, or other business-related processes.

The term “shortage of human resources” refers to a condition in which the available human workforce is insufficient to handle a desired amount of tasks or interactions without assistance from automated systems.

The term “information provision” refers to a process in which data, explanations, or recommendations are delivered to a recipient through a computing system.

The term “transaction activities” refers to operations related to proposing, negotiating, or executing exchanges of goods, services, or other items of value.

The term “target” refers to an entity, such as a customer, user, or counterpart, for whom the system performs analysis, provides information, or supports interactions.

The term “attribute information” refers to data describing characteristics or properties of a target, including demographic details, preferences, history, or status.

The term “dialogue content” refers to linguistic information, including spoken or written utterances, exchanged between a user and a target during an interaction.

The term “natural language processing” refers to computational techniques for analyzing, understanding, and generating human language in textual or transcribed form.

The term “proposal information” refers to content that suggests specific actions, plans, or options tailored to a target, such as recommended offerings, responses, or strategies.

The term “terminal” refers to a user-side computing device, such as a mobile device, personal computer, or client apparatus, configured to capture, transmit, receive, and display data in connection with the server.

The term “voice data” refers to digital data representing an audio signal of speech, obtained by sampling and encoding sound produced by a target.

The term “preprocessing” refers to a set of operations performed on raw data prior to analysis, including transformations that enhance quality or normalize format.

The term “noise reduction” refers to a signal processing operation that decreases or removes unwanted background or interference components from voice data.

The term “volume normalization” refers to an operation that adjusts the amplitude or loudness of voice data to a desired reference level or range.

The term “acoustic feature values” refers to numerical descriptors derived from voice data, representing properties such as tone, volume, speaking speed, and speech pattern.

The term “tone” refers to a characteristic of voice related to pitch or fundamental frequency, including patterns of intonation over time.

The term “volume” refers to a characteristic of voice related to amplitude or loudness of the audio signal.

The term “speaking speed” refers to a measure of how quickly a target speaks, such as words or syllables per unit time.

The term “speech pattern” refers to temporal and prosodic characteristics of speech, including rhythm, pause structure, and intonation contours.

The term “voice analysis algorithm” refers to a computational method or set of methods that processes voice data to derive acoustic feature values or other analytical results.

The term “learning data” refers to a collection of training samples, including input features and corresponding labels or targets, used to train a generative AI model.

The term “psychological state” refers to an internal condition of a target, such as emotional or mental state, estimated from observable data including acoustic features.

The term “analysis process” refers to a sequence of computational operations performed to derive higher-level information, such as a psychological state, from input data.

The term “domain-specific knowledge” refers to information related to a particular field or application area, such as negotiation practices, product information, or industry guidelines, used to contextualize generated guidance.

The term “guidance information” refers to generated content, including recommendations, strategies, or policies, intended to assist a user in conducting interactions or making decisions.

The term “negotiation policy” refers to a set of recommended actions, tactics, or approaches for managing a negotiation or interaction in view of a target's state.

The term “response policy” refers to recommended manners of replying, including tone and content, to a target based on contextual and analytical information.

The term “user-entered prompt sentence” refers to a prompt sentence that is manually input by a user to specify a desired type of guidance or analysis from the generative AI model.

The term “progress information of a dialogue” refers to data indicating temporal development or stages of an interaction, including sequence of utterances and changes over time.

The term “past successful case data” refers to stored records of previous interactions or transactions that achieved a desired outcome, including associated conditions and states.

The term “support information” refers to generated content that assists a user in improving or completing an interaction, including explanatory content, question content, or material structure.

The term “explanatory content” refers to text or other media that clarifies features, benefits, procedures, or other aspects relevant to a target.

The term “question content” refers to suggested inquiries or prompts that a user may ask a target to obtain additional information or clarify needs.

The term “material structure” refers to an organized arrangement or outline of information resources, such as documents or presentation elements, for use in an interaction.

The term “language type” refers to a specific natural language, such as a national or regional language, in which information is communicated.

The term “regional information” refers to data indicating geographic or cultural context associated with a target, such as country or region.

The term “machine translation” refers to an automated computational process that converts text from one natural language to another without human translation effort.

In one embodiment, a server, a terminal, and a user cooperate to implement the invention. The server includes at least one processor, a memory, a non-transitory storage medium, and a network interface. The terminal includes a processor, a memory, a microphone, a display, a user input interface, and a communication interface. The user operates the terminal to conduct interactions with a target and to request analysis and guidance.

The server stores in the memory a plurality of software modules, including a web service module, an audio pre-processing module, an acoustic feature extraction module, a psychological state estimation module, a prompt orchestration module, a generative AI inference module, and a guidance presentation module. The server also stores, in the non-transitory storage medium, learning data for training machine learning models, model parameters, and historical case data. The terminal stores an application program that communicates with the server and provides a graphical user interface.

The terminal uses the microphone hardware and an audio capture subsystem to convert analog sound pressure from the target into digital voice data. The terminal uses a sampling rate, such as 16 kHz or 44.1 kHz, and a quantization resolution, such as 16-bit linear PCM, to generate a digital waveform. The terminal encodes the waveform into a common audio container format, such as a waveform audio file format or an advanced audio coding format, and stores the audio data in a local file system. The terminal generates metadata, such as a session identifier, timestamp, and approximate duration, and associates this metadata with the stored audio data.

The terminal uses a communication interface and a network protocol, such as HTTPS over TCP/IP, to transmit the voice data and associated metadata to the server. The terminal uses a client-side HTTP library to construct and send a request message that contains the audio file as a binary payload or multipart form data. The server uses a web service framework to receive the request, authenticate the user if necessary, and store the raw audio file in a server-side storage area.

The server uses the audio pre-processing module to perform digital signal processing on the received audio data. The server uses an audio processing library, such as a general-purpose multimedia framework and a numerical computation library, to decode the file into a time-domain waveform represented as an array of floating point values. The server applies a noise reduction algorithm that estimates a noise spectrum from low-energy segments using a short-time Fourier transform, computes a spectral mask based on a noise model, and applies the mask to each frequency bin to suppress noise components. The server applies a volume normalization algorithm that computes a loudness measure, such as root mean square or integrated loudness, determines a gain factor to match a target level, and scales the waveform samples accordingly.

The server uses the acoustic feature extraction module to convert the pre-processed waveform into acoustic feature values. The server divides the waveform into overlapping frames and applies a window function to each frame. The server calculates time-frequency representations, such as a mel-spectrogram or a log-mel power spectrum, by applying a fast Fourier transform and a filter bank. The server calculates tone-related features including fundamental frequency using an algorithm such as YIN or autocorrelation-based pitch detection; the server records pitch contour over time and statistics such as mean, variance, and range. The server calculates volume-related features including frame-level energy, peak amplitude, and dynamic range. The server calculates speaking speed features by performing voice activity detection, segmenting speech and silence intervals, and determining speech rate as words or syllables per unit time based on energy peaks or phonetic segmentation. The server calculates speech pattern features including pause length distribution, rhythm regularity, pitch rise and fall patterns, and prosodic contours.

The server stores these acoustic feature values in a structured data format, such as a multi-dimensional array or tensor, indexed by time frame and feature type. The server also maintains a data structure that links the feature tensor to the session identifier and to any additional context, such as language type or domain.

The server uses the psychological state estimation module to process the acoustic feature values with a generative AI model. In one embodiment, the server uses a transformer-based neural network that receives sequences of feature vectors as input. The server normalizes the feature values using pre-computed means and standard deviations, embeds the normalized features into a latent space using linear projection layers, and applies a stack of self-attention layers with multiple attention heads to model temporal dependencies in tone, volume, speaking speed, and speech pattern. The server uses feed-forward sublayers, residual connections, and normalization layers within each block to stabilize training and inference.

The server uses an output layer, such as a softmax classifier, to generate a probability distribution over a set of predefined psychological state labels, and optionally uses regression heads to output continuous scores for arousal, valence, or engagement.

The server trains the generative AI model offline by using learning data that includes pairs of acoustic feature sequences and ground truth labels for psychological states. The server uses a supervised learning algorithm with a loss function such as cross-entropy for classification and mean squared error for regression. The server updates the model parameters by gradient-based optimization, such as stochastic gradient descent or an adaptive optimizer. The server optionally performs data augmentation, such as adding synthetic noise, shifting pitch slightly, or modifying tempo, to increase robustness. The server stores the trained model weights in the non-transitory storage medium and loads them into memory for inference.

The server uses the generative AI inference module during runtime to compute psychological state estimates for new sessions. The server feeds the feature tensor into the model, obtains the output probability distribution and continuous scores, and applies decision logic that may include temporal smoothing, hysteresis thresholds, or combining multiple time windows to avoid rapid fluctuations. The server produces an analysis result object containing fields such as primary psychological state, secondary psychological state, confidence scores, and state evolution over the session.

The server uses the prompt orchestration module to generate a prompt sentence that instructs the generative AI model used for text generation how to integrate the psychological analysis with domain-specific knowledge and user intent. The server constructs a base system prompt that defines the role and behavior of the generative AI model, for example as an assistant for negotiation guidance. The server inserts into the prompt a natural language summary of the estimated psychological state, including tone, volume, speaking speed, and speech patterns that contributed to the estimation. The server additionally includes a concise description of the business or domain context.

The user uses the terminal to input a user-specific prompt sentence that reflects the user's request for guidance. The user enters text, for example:

“Please propose three negotiation strategies if the customer is excited and speaking very fast.”

“Given that the customer sounds calm but hesitant, what follow-up questions should I ask to clarify their concerns?”

“Suggest a polite response when the customer's tone indicates frustration about pricing.” The user can also enter text in another language, for example:

“Please propose closing strategies if the customer is excited”

“Create three closing phrases that are effective when the customer speaks slowly and in a low tone.”

“Provide an example of an opening speech to ease the customer's concerns in their next business meeting.”

The terminal sends the user-entered prompt sentence together with a session identifier to the server. The server combines this user-entered prompt sentence with the psychological analysis and domain-specific knowledge in a single composite prompt sentence or a structured series of textual instructions. The server then sends this composite prompt sentence to a text-generative AI model, which may be a transformer-based language model deployed locally or accessed via an API endpoint.

The server uses a generative AI model architecture that includes an embedding layer for input tokens, a stack of self-attention blocks, and an output layer that produces the next-token distribution. The server fine-tunes this generative AI model on a corpus of domain-specific dialogue examples and negotiation strategies. During fine-tuning, the server uses a loss function such as cross-entropy between model output tokens and reference tokens, and updates the model weights via gradient descent. The server maintains separate parameter sets for different domains if necessary.

During inference, the server constrains the generative AI model by applying decoding strategies such as top-k sampling or nucleus sampling with a specified temperature parameter. The server sets these parameters to balance diversity and consistency of generated guidance. The server applies length constraints, controlled generation tags, or structural templates so that the output guidance information is provided in a predictable format, such as numbered strategies, bullet-point rationales, and example utterances.

The server outputs guidance information including a negotiation policy or response policy.

The server structures the guidance information into segments, for example: “Summary of psychological state”, “Recommended high-level strategy”, and “Concrete example phrases”.

The server stores this guidance information in a response object and transmits it to the terminal over the network. The terminal displays the guidance information on the display in a readable layout, allowing the user to view and scroll through strategies and example phrases.

In one embodiment, the server uses the psychological state estimation module and historical case data to generate support information. The server retrieves past successful case data from a database, where each case includes psychological profiles, interaction summaries, and successful outcomes. The server compares the current psychological state and dialogue progress information with the stored cases using similarity metrics, such as cosine similarity over learned embeddings or distance measures over feature vectors. The server identifies cases that exhibit similar patterns of psychological state evolution and uses these matches to refine the prompt sentence, requesting generation of explanatory content, question content, or material structure that has proven effective in similar situations. This non-conventional use of case-based similarity at the feature level enables the system to adapt guidance to complex patterns in a way that manual rule-based systems cannot practically achieve.

In another embodiment, the server uses a language type and regional information to generate multilingual guidance information. The server includes in the composite prompt sentence an instruction indicating the target language, such as “Output the guidance in English” or “Please write the output in Japanese.” The server may additionally use a separate machine translation engine to translate guidance information into multiple languages. By performing translation server-side and by structuring the guidance information into stable units, the server reduces redundant re-generation operations, thereby lowering communication load and improving response time for terminals that request different language versions.

The system provides technical improvements over conventional approaches in several ways. Because the server performs noise reduction and volume normalization before feature extraction, the acoustic features become more stable and less sensitive to recording environment variations. This reduces the variance in the input to the generative AI model, which in turn reduces error rates in psychological state estimation. Because the server uses frame-based feature extraction and transformer-based modeling, the system can process long audio sequences efficiently while capturing long-range dependencies without excessive memory usage, leading to improved computation efficiency as compared to naïve recurrent architectures.

Because the server centrally orchestrates the generation of prompt sentences that specify each computational stage—preprocessing, feature extraction, psychological estimation, and guidance generation—the system reduces misconfiguration of the generative AI model and ensures consistent use of model capabilities. This orchestration is not a mere automation of human judgment, but an explicit control over how the computational modules interoperate. The prompt orchestration module programmatically modulates the behavior of large models in real time based on acoustic and historical patterns that a human operator cannot reliably calculate at comparable speed or scale.

The server implements non-conventional rules for mapping acoustic features and case similarity measures into structured prompt sentences. For example, the server inserts specific conditions, such as “The customer's speaking speed is in the top 10% of recorded sessions and the arousal score exceeds a threshold,” and requests the generative AI model to favor strategies that reduce pace and confirm understanding. These computational rules operate at the feature and probability distribution level, which are not directly accessible to human operators, and thereby constitute an improvement in how computer systems interpret and use audio-analytic signals.

The system also improves data management and communication efficiency. By separating acoustic feature tensors and high-level psychological summaries, the server can cache and reuse intermediate analysis results for multiple prompt sentences from the same session, avoiding re-computation of signal processing and model inference. This reduces processing time and server load when the user submits multiple prompt sentences to refine strategies.

The server also reduces network bandwidth usage because only text-based psychological summaries and guidance information are transmitted between the server and terminal after the initial audio upload.

In alternative embodiments, the server may use different neural network architectures for psychological state estimation, such as a convolutional neural network applied to spectrogram images or a hybrid architecture combining recurrent layers with attention. The server may also use different feature sets, including spectral features like mel-frequency cepstral coefficients, jitter, shimmer, and speech rate measures derived from automatic speech recognition transcripts. In another variation, the server divides the audio into conversational turns and computes turn-level psychological states to capture changes over time with finer granularity.

The terminal can be implemented as a mobile device, a desktop computer, or an embedded client device in a communication system. The terminal may optionally perform lightweight preprocessing, such as downsampling or compression, before uploading, to reduce communication load. The user may interact with the system through voice input in addition to text input, with the terminal transcribing the user's voice into a prompt sentence using an automatic speech recognition component.

Through these embodiments, the server, the terminal, and the user cooperate to implement a system in which generative AI models are controlled by technically structured prompt sentences, acoustic features are exploited with specialized neural architectures, and historical data is integrated at the feature level. This configuration yields tangible technical effects such as improved accuracy and stability of psychological state estimation, reduced latency for guidance generation, improved scalability for many concurrent sessions, and decreased communication overhead, thereby improving the functioning of the computer system itself rather than merely automating a human cognitive process.

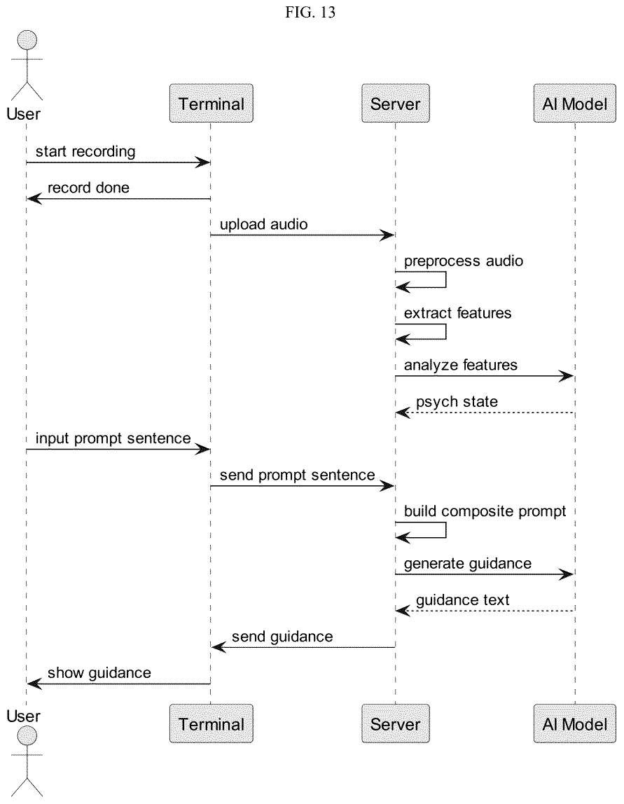

The following describes the processing flow using FIG. 13.

### Step 1:

The user operates the terminal to record a conversation with a target.

Input: Analog speech of the target and the user.

Output: A digital audio file and associated metadata stored on the terminal.

The terminal uses the microphone hardware and an audio capture subsystem to sample the analog sound at a predetermined sampling rate (for example, 16 kHz) and quantization depth (for example, 16-bit PCM). The terminal converts the continuous waveform into a sequence of digital samples and encodes the samples into an audio file format such as WAV or AAC. The terminal additionally creates metadata including a session identifier, timestamp, device identifier, and approximate duration, and stores this metadata in a local data structure linked to the audio file.

### Step 2:

The terminal uploads the recorded audio data and metadata to the server.

Input: The audio file and metadata stored on the terminal.

Output: The audio file and metadata stored on the server.

The terminal reads the audio file from local storage into a binary buffer and retrieves the associated metadata structure. The terminal establishes a secure network connection, such as HTTPS, to the server and constructs an HTTP request that includes the audio buffer as multipart or binary content and the metadata as header fields or a JSON body. The server receives the request using a web service framework, validates the request, and writes the audio buffer to a server-side storage area, registering the session identifier and metadata in a database or index table.

### Step 3:

The server performs audio decoding and preprocessing on the received audio data.

Input: The stored audio file and metadata on the server.

Output: A preprocessed waveform array ready for feature extraction.

The server invokes an audio processing module to decode the audio file into a time-domain waveform represented as an array of floating-point samples. The server analyzes the waveform to detect low-energy regions and estimates a noise profile in the frequency domain using a short-time Fourier transform. The server computes a spectral mask by comparing the magnitude spectrum of speech segments with the estimated noise spectrum and applies this mask to attenuate noise. The server then calculates the root mean square level or a loudness measure of the denoised signal, determines a gain factor to reach a target loudness, and multiplies each sample by the gain factor. The server outputs a normalized waveform array associated with the original session identifier.

### Step 4:

The server extracts acoustic feature values from the preprocessed waveform.

Input: The preprocessed waveform array and session metadata.

Output: A feature tensor representing tone, volume, speaking speed, and speech pattern.

The server segments the waveform into overlapping frames of fixed length (for example, 25 ms) with a defined hop size (for example, 10 ms) and applies a window function to each frame. The server computes a fast Fourier transform for each frame and converts the magnitude spectrum into a mel-spectrogram or log-mel energy representation. The server calculates pitch (tone) per frame using a pitch detection algorithm and stores the pitch contour. The server computes volume features such as frame-level energy and peak amplitude. The server runs a voice activity detector to distinguish speech from silence and measures speaking speed by calculating speech segment durations and estimating syllable or word rates. The server analyzes pauses, rhythm, and intonation contours to derive speech pattern features. The server aggregates these values into a multi-dimensional tensor indexed by time frames and feature types, and associates this tensor with the session identifier.

### Step 5:

The server estimates the psychological state of the target using a generative AI model configured for sequence analysis.

Input: The acoustic feature tensor for the session.

Output: A psychological state analysis object including state labels and confidence scores.

The server normalizes each feature dimension of the tensor using stored mean and variance values and converts the normalized tensor into the input format required by a transformer-based neural network. The server passes the tensor through an input projection layer to obtain latent embeddings and feeds these embeddings into multiple self-attention layers that compute attention weights over time to model dependencies among frames. The server processes the attention outputs through feed-forward layers and normalization layers and applies an output head that produces a probability distribution over predefined psychological state categories and continuous scores such as arousal and valence. The server optionally applies a temporal smoothing algorithm across successive time windows to reduce fluctuations. The server packages the primary and secondary states, the probability scores, and any time-series curves into an analysis object indexed by session identifier.

### Step 6:

The server generates a psychological summary text based on the analysis object.

Input: The psychological state analysis object.

Output: A textual summary of the psychological state and relevant acoustic indicators.

The server reads the primary and secondary psychological states, confidence scores, and feature-based evidence such as high speaking speed or elevated volume. The server constructs a human-readable summary sentence or paragraph, for example by filling a template that describes the intensity and nature of the emotional state and referencing the acoustic cues (e.g., “The target speaks at a higher-than-average rate with frequent rising intonation, indicating excitement and moderate anxiety.”). The server stores this summary text in association with the session identifier.

### Step 7:

The user inputs a prompt sentence requesting negotiation or response guidance.

Input: The user's intention and the terminal's user interface.

Output: A user-entered prompt sentence transmitted to the server.

The user reads basic information about the interaction on the terminal and types a prompt sentence into a text input interface. The prompt sentence may be, for example, “Please propose three negotiation strategies if the customer is excited and speaking very fast.” or “Suggest a polite response when the customer's tone indicates frustration about pricing.” The terminal captures the input string, attaches the corresponding session identifier, and sends it to the server via an HTTP request.

### Step 8:

The server constructs a composite prompt sentence for a text-generative AI model.

Input: The psychological summary text and the user-entered prompt sentence.

Output: A composite prompt sentence for the text-generative AI model.

The server retrieves the psychological summary text for the session and concatenates it with the user-entered prompt sentence in a structured manner. The server may prepend system-level instructions that define the role of the generative AI model, such as “You are a negotiation support assistant.” The server then appends the psychological summary, for example, “The customer appears excited and slightly anxious, with high speaking speed and elevated volume,” and finally appends the user's prompt sentence requesting specific strategies or example responses. The server forms a single composite prompt sentence or a sequence of instruction segments that will guide the generative AI model's output.

### Step 9:

The server generates guidance information using the text-based generative AI model.

Input: The composite prompt sentence.

Output: Guidance information including a negotiation policy, response policy, and example utterances.

The server tokenizes the composite prompt sentence into tokens suitable for the language model and passes the token sequence into the embedding layer of a transformer-based text generator. The server processes the token embeddings through multiple attention layers that capture relationships between the psychological description, domain instructions, and user request. The server uses a decoding algorithm, such as top-k or nucleus sampling with a specified temperature and maximum length, to generate an output token sequence. The server converts the tokens back into text, yielding guidance information such as structured strategies, rationales, and example phrases. The server parses the generated text into logical sections (e.g., Strategy 1, Strategy 2, Example Sentences) and formats it as a guidance object associated with the session.

### Step 10:

The server transmits the guidance information to the terminal and the terminal displays it to the user.

Input: The guidance object generated by the server.

Output: A rendered guidance view on the terminal display.

The server embeds the guidance object in a response message, serializes it into a suitable format, and sends it over the network to the terminal. The terminal receives the response, parses the guidance text, and maps the sections to user interface components. The terminal renders headings, bullet points, and example sentences on the display and allows the user to scroll and select portions of the guidance if needed. The user reads the guidance and applies the suggested negotiation policy or response policy in subsequent interactions with the target.

### Step 11:

The server optionally refines guidance by comparing the current analysis with historical case data.

Input: The psychological state analysis object and historical successful case data.

Output: Updated guidance parameters or additional supporting suggestions.

The server maps the current psychological state analysis to a feature vector and compares this vector against stored feature vectors from past successful cases using a similarity metric such as cosine similarity. The server selects the most similar cases and extracts their associated strategies and outcomes. The server incorporates this information into a new composite prompt sentence that instructs the generative AI model to generate guidance aligned with previously successful patterns. The server then repeats the text generation process, producing refined or augmented guidance that is sent to the terminal for display.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented sales support systems mainly focus on static rule-based recommendations or simple correlation between transaction history and purchase history. Such systems typically treat customer inputs as isolated events, and they do not deeply integrate multimodal information such as speech content, acoustic features, and time-varying emotional signals with large-scale behavioral data such as transaction logs, purchase histories, and browsing histories. As a result, the underlying information processing architecture cannot adapt its operation in real time to the user's psychological state, and cannot automatically generate context-appropriate sales proposals or closing messages. Further, in many existing architectures, a generative AI model, if used at all, is invoked in an ad-hoc manner with manually crafted prompts that are not systematically tied to machine-readable user profiles, detected emotional states, or gap analyses between proposed and purchased items. This leads to non-deterministic, inconsistent outputs and makes it difficult for the system to reliably automate critical portions of the sales process or to scale to a large number of simultaneous sessions.

Moreover, conventional systems do not provide a closed feedback loop in which past transaction outcomes, inquiry histories, presentation materials, and emotion analysis results are automatically stored and exploited as learning data to update the parameters of machine learning components and improve future processing. Without such a loop, the computer system cannot efficiently refine its models and prompt generation logic, and therefore cannot systematically improve the quality and stability of its generative outputs over time.

In addition, typical multi-language support is implemented as a separate, superficial translation layer that is not integrated with emotion-aware proposal generation or automated closing support. Consequently, the core computation does not optimize its behavior for different linguistic contexts and time zones, and the system cannot provide high-quality, multilingual, always-available responses without significant manual intervention. Accordingly, there is a need for a computer-implemented system and processing architecture that (i) acquires and fuses speech-derived emotional and psychological states with rich behavioral history, (ii) automatically constructs structured prompt sentences for a generative AI model based on such integrated context, (iii) generates and delivers emotion-adaptive proposal documents and proposal videos in real time to user terminals, and (iv) continuously updates internal models and prompt generation logic based on accumulated learning data, thereby improving the technical performance, scalability, and reliability of computer-implemented sales support and customer interaction processing.

The specific processing by the specific processing unit 290 of the data processing device 12 in Application Example 2 is realized by the following means.

The present invention provides a server comprising a processor configured to acquire voice information from a user terminal, convert the voice information into character information and acoustic feature information using a speech recognition function and an acoustic feature extraction function, estimate an emotional state and a psychological state of a user on the basis of the character information and the acoustic feature information, analyze temporal change information of the emotional state and the psychological state together with behavior history information including transaction history information, purchase history information, and browsing history information using an information analysis function and a machine learning function, generate user profile information and proposal candidate information from the analysis, automatically construct a structured prompt sentence for a generative information processing model based on the user profile information, the proposal candidate information, and the emotional state so as to instruct the generative information processing model to execute at least a part of a sales process, obtain proposal information including at least a personalized proposal text, a closing-support text, and a proposal-video script from the generative information processing model, transform the proposal information into proposal document data and proposal video data using a document generation function and a video generation function, transmit the proposal information and the emotional state in real time to a visual display device of the user terminal to support face-to-face interaction, store past transaction result information, inquiry information, explanation material information, and emotional states as learning information, update operation parameters of the machine learning function and the generative information processing model on the basis of the learning information, and convert the proposal information and the closing-support text into multiple languages using a natural language processing function and a machine translation function to generate multilingual proposal information for automatic, time-independent responses. This enables the computer system to improve its internal information processing capabilities by tightly integrating multimodal emotion analysis, behavioral data analytics, and adaptive prompt generation for a generative AI model, thereby providing technically enhanced, emotion-adaptive, multilingual, and continuously self-optimizing sales support and customer interaction processing.

The term “voice information” refers to audio data representing speech uttered by a person, including but not limited to waveforms or encoded audio samples suitable for processing by a computing device.

The term “user terminal” refers to an information processing device operated by a user, such as a mobile device, a head-mounted display device, or a general-purpose computing device, that is configured to capture, transmit, receive, and/or display information.

The term “speech recognition function” refers to a software-implemented or hardware-implemented function that converts voice information into character information representing the linguistic content of the speech.

The term “acoustic feature extraction function” refers to a software-implemented or hardware-implemented function that analyzes voice information to derive numerical or categorical features, including at least volume, pitch, speaking rate, and pause patterns.

The term “character information” refers to text data obtained by converting voice information into a sequence of characters or symbols that can be analyzed by a computing device.

The term “acoustic feature information” refers to structured data representing acoustic characteristics of voice information, including one or more of tone, volume level, pitch contour, speaking speed, and temporal distribution of pauses.

The term “emotional state” refers to a state indicating affective characteristics of a user, such as joy, anxiety, dissatisfaction, interest, or confidence, inferred from at least one of character information and acoustic feature information.

The term “psychological state” refers to a state indicating cognitive or motivational aspects of a user, including at least degrees of interest, anxiety, and satisfaction in relation to a product, service, or interaction context, inferred from multimodal input data.

The term “temporal change information” refers to information indicating variation of at least one of the emotional state and the psychological state over time during a session or across multiple sessions.

The term “behavior history information” refers to accumulated digital records relating to actions of a user, including transaction history information, purchase history information, and browsing history information.

The term “transaction history information” refers to data representing past commercial negotiations or interactions, such as proposals made, conditions discussed, and outcomes of commercial discussions.

The term “purchase history information” refers to data representing items or services acquired by a user in the past, including identifiers of purchased items, quantities, timestamps, and pricing data.

The term “browsing history information” refers to data indicating past access behavior of a user with respect to digital content, including viewed product pages, interaction timestamps, and navigation sequences.

The term “information analysis function” refers to a function implemented by software or hardware that performs at least one of aggregation, comparison, correlation, and pattern extraction on behavior history information and other related data.

The term “machine learning function” refers to a function implemented by a computing system that trains or executes a model based on training data to infer patterns or predictions, such as predicting purchase likelihood or classifying emotional states.

The term “user profile information” refers to structured data describing attributes and inferred preferences of a user, including at least a degree of interest, a degree of anxiety, and a degree of satisfaction with respect to products or services.

The term “proposal candidate information” refers to information identifying one or more candidate products, services, or bundles that may be proposed to a user, derived from analysis of user profile information and behavior history information.

The term “generative information processing model” refers to a generative AI model configured to generate text, scripts, or other content on the basis of input data and instructions, including at least a large-scale language model.

The term “prompt sentence” refers to a structured natural-language or machine-readable instruction provided to a generative information processing model, the instruction specifying a task, constraints, and contextual data for content generation.

The term “sales process” refers to a sequence of operations associated with marketing or selling a product or service, including at least proposal generation, objection handling, and closing support.

The term “proposal information” refers to information output from the generative information processing model, including at least a personalized proposal text, a closing-support text, and a proposal-video script for presentation to a user.

The term “personalized proposal text” refers to text content of a proposal that is adapted to individual attributes, preferences, and emotional states of a specific user.

The term “closing-support text” refers to text content designed to assist in finalizing a transaction, including suggested phrases, discount strategies, and explanations tailored to a user's current state.

The term “proposal-video script” refers to structured text or metadata specifying scenes, narration, and key messages for generating or editing a video used to present a proposal.

The term “document generation function” refers to a function that transforms proposal information into formatted electronic documents, such as files in a page-description or document format suitable for presentation or printing.

The term “video generation function” refers to a function that generates or edits video data based on a proposal-video script, including the composition of images, text overlays, and audio elements.

The term “proposal document data” refers to digital document data representing a proposal, including formatted text, tables, and graphical elements suitable for display or distribution.

The term “proposal video data” refers to digital video data representing a proposal in audiovisual form, generated or edited based on proposal-video scripts.

The term “visual display device” refers to a display unit of a user terminal configured to visually present information, including at least head-mounted displays, wearable displays, and general-purpose display screens.

The term “commercial discussion” refers to an interaction between parties relating to potential purchase or provision of a product or service, including exchange of conditions, explanations, and objections.

The term “recommended response” refers to guidance information generated by the system, indicating a suggested reply, explanation, or action for a user to take during a commercial discussion.

The term “transaction result information” refers to data indicating outcomes of commercial discussions, including whether a deal was concluded, what items were purchased, and which conditions were accepted.

The term “inquiry information” refers to data representing questions, issues, or requests raised by a user through channels such as voice input, messages, or electronic mail.

The term “explanation material information” refers to data representing explanatory documents, manuals, case studies, or presentation materials used in past or current commercial discussions.

The term “learning information” refers to data used to train or update machine learning models, including at least transaction result information, inquiry information, explanation material information, and associated emotional states.

The term “operation parameters” refers to adjustable values that control behavior of the machine learning function or the generative information processing model, including weights, thresholds, and hyperparameters.

The term “natural language processing function” refers to a function that analyzes or generates human language text, including tokenization, parsing, entity recognition, and text generation.

The term “machine translation function” refers to a function that automatically converts text from one natural language into another natural language using algorithmic transformation.

The term “multilingual proposal information” refers to proposal information that is available in two or more natural languages, produced by applying a natural language processing function and a machine translation function to original proposal information.

The term “automatic, time-independent responses” refers to responses generated and delivered by the system without human intervention and without restriction to particular time periods, enabling continuous operation.

According to one embodiment, the invention is implemented by a server, one or more terminals, and one or more users interacting via a communication network. The server executes a plurality of software modules on one or more processors and memories, and the terminals provide input and output interfaces including microphones, displays, and optionally head-mounted visual display devices.

The server uses conventional computing hardware, such as a multi-core central processing unit, a graphics processing unit, a volatile memory device, a non-volatile storage device, and a network interface. The server executes an operating system, a runtime environment for a high-level language (for example, a virtual machine or an interpreter), and an application program that implements speech processing, data analysis, machine learning, and generative AI coordination. The server may integrate with external cloud-based application programming interfaces for speech recognition and sentiment analysis. For example, the server can call a speech-to-text service, an emotion-analysis service, or a translation service via a network, but the control logic and data flow described below reside on the server. The terminal uses general-purpose hardware such as a mobile computing device, a head-mounted device, or a desktop computing device, equipped with an audio input transducer and a visual output device. The terminal executes a client application that communicates with the server using a secure protocol. The user interacts with the system by speaking near the microphone, viewing information on the display, and optionally issuing commands by touch or voice.

The server processes voice information by first converting analog audio captured at the terminal into digital samples and then transforming the digital samples into character information and acoustic feature information. The server uses a speech recognition function that may rely on an acoustic model and a language model to map time-domain audio frames into sequences of subword units and then into words. The acoustic feature extraction function of the server computes a feature vector sequence including at least energy, spectral coefficients, pitch, and speaking rate, and aggregates these features into acoustic feature information that describes tone, volume level, prosody, and pause patterns.

The server further infers an emotional state and a psychological state from the character information and acoustic feature information. In one implementation, the server uses a neural network classifier with multiple layers, such as an input layer that receives feature vectors, one or more hidden layers formed by non-linear units, and an output layer representing emotion categories. The server uses a categorical cross-entropy loss function and a gradient-based optimization method to train the classifier on labeled audio-text pairs, and then applies the trained classifier at runtime to compute probability scores for emotion labels.

The server thereby obtains an emotional state vector and an associated confidence value for each utterance.

The server also generates and maintains behavior history information for each user. The server stores transaction history information, purchase history information, and browsing history information in a relational or columnar database with indexed tables and foreign-key relations. The server creates, for each user, a user profile record containing values such as aggregate spend by category, recency and frequency metrics, and historical response patterns to prior proposals. The server updates these records when new interactions occur.

The server uses an information analysis function and a machine learning function to integrate the emotional state and psychological state with the behavior history information. For example, the server loads behavior history records into a tabular data structure, associates them with time-stamped emotion vectors, and computes joint features such as “probability of purchase when anxiety level is high” or “average dwell time on product pages when interest level exceeds a threshold.” The machine learning function may comprise a neural network, a gradient-boosted decision tree, or another predictive model that receives such features as inputs and outputs scores for degrees of interest, anxiety, and satisfaction for different product groups. In this way, the server generates user profile information that is dynamically updated to capture both long-term behavior and short-term emotional context.

The server constructs proposal candidate information by selecting candidate products or services using the user profile information and the behavior history information. The server may use a recommendation model, such as an embedding-based neural network that maps users and items into a shared latent space. The server calculates similarity measures between user and item embeddings to rank items by predicted relevance and filters the ranking according to availability and policy rules. Thus, the server obtains a proposal candidate list with associated relevance scores.

The server prepares a prompt sentence for a generative AI model by programmatically assembling a structured natural-language instruction that describes the user profile information, the proposal candidate information, and the current emotional state. The server divides the prompt sentence into segments, including a role specification (“You are a professional sales advisor”), a task description (“Create a proposal tailored to the following user profile and emotional state”), a constraint description (“Use polite language, limit the length, highlight long-term value”), and a context section summarizing user attributes and product candidates. The resulting prompt sentence is therefore not hand-crafted for each session by a human, but instead algorithmically generated following reproducible rules and templates.

The server then transmits the prompt sentence to a generative AI model that may be executed on an external computation platform or on the server itself. In one embodiment, the generative AI model is a transformer-based neural network comprising a token embedding layer, multiple self-attention blocks, and a language modeling head. The generative AI model has been pre-trained on large text corpora and optionally fine-tuned on domain-specific training data. The generative AI model receives the prompt sentence as an input token sequence and generates a sequence of output tokens that form proposal information including a personalized proposal text, a closing-support text, and a proposal-video script.

The server validates and post-processes the generated proposal information. The server checks whether required sections are present and whether the output length and format comply with internal constraints. If the output does not satisfy the conditions, the server modifies the prompt sentence by inserting additional constraints or clarifying the task, and resubmits the prompt sentence to the generative AI model. In this manner, the server implements a control loop that systematically shapes generative outputs to conform to technical specifications, thereby improving consistency and predictability of AI-generated content.

The server transforms the proposal information into proposal document data and proposal video data. The server uses a document generation function to insert the personalized proposal text and closing-support text into a template that includes structured fields such as headers, tables, and graphical indicators. The server produces an electronic document file in a standard format that can be rendered uniformly on heterogeneous terminals. The server uses a video generation function to convert the proposal-video script into video sequences, by selecting pre-stored image frames, applying dynamic overlays, and synthesizing narration audio. By structuring the script as time-aligned segments with tokens specifying scene types, transitions, and emphasis, the server enables deterministic mapping from textual instructions to audiovisual content.

The terminal receives the proposal document data and proposal video data from the server and presents them to the user. The terminal renders text and graphics on its visual display device and plays video content when appropriate. In configurations where the terminal includes a head-mounted display, the terminal overlays short proposal messages and emotional indicators in the field of view. The user thereby receives real-time guidance synchronized with the ongoing commercial discussion.

The server also transmits the current emotional state and recommended responses to the terminal in real time. The server compresses emotional state vectors into compact codes that represent classes such as “interested but anxious” or “satisfied and ready to close.” The server transmits these codes together with concise textual hints. The terminal decodes the information and displays brief messages, such as “Customer seems anxious about price; emphasize long-term savings,” which are directly derived from the output of the classifier and the mapping rules in the server. This encoding and transmission reduce communication load and latency compared to sending full transcripts or raw feature sequences, thereby improving responsiveness.

The server records transaction result information, inquiry information, explanation material information, and associated emotional states as learning information in storage. The server periodically uses the learning information to refine the machine learning function and the generative AI control logic. For example, the server can evaluate which generated proposals led to successful closings, and then adjust model parameters or prompt sentence templates to increase emphasis on patterns correlated with success. The server may use supervised-learning updates with a loss function that penalizes divergence between predicted success probabilities and actual outcomes, and may also adjust weights assigned to emotional features when training.

The server further applies a natural language processing function and a machine translation function to the proposal information and closing-support text to create multilingual proposal information. The server segments text into sentences, analyzes syntactic structure, and then submits the text to a translation engine. The server stores results as a set of language-indexed variants of the proposal information. In multi-language scenarios, the server selects the appropriate localized version based on terminal settings or user preferences and thus provides automatic, time-independent responses to users in different regions and time zones. The described architecture yields several technical effects beyond simple automation of human tasks. By unifying multimodal emotion analysis, behavior history analytics, and generative prompt construction in a single data flow, the server reduces redundant data transfers and repeated parsing operations that would otherwise occur in loosely-coupled systems. The server maintains compact vector representations of emotional states and user profiles, and reuses these representations across components, reducing memory footprint and computational overhead. The systematic generation and adjustment of prompt sentences allow the generative AI model to operate with narrower, better-defined search spaces, which improves convergence speed and reduces the likelihood of incoherent outputs.

Because the server continuously updates model parameters and prompt generation rules based on learning information, the system improves recognition accuracy and proposal relevance over time without a corresponding increase in manual configuration. The emotion classifier can lower false positive and false negative rates as more labeled examples are accumulated, and the recommendation model can better capture non-linear interactions between user behavior and emotional context. This iterative improvement leads to lower error rates in predicting user preferences, faster computation of recommendations, and more efficient use of network bandwidth for transmitting only essential, processed information to terminals.

In addition, the described system uses processing rules and model architectures that are not simple digital replicas of human cognitive steps. The server applies non-intuitive combinations of features, such as joint embeddings of browsing sequences and emotion trajectories, and optimizes model weights using gradient-based methods that exploit patterns beyond human manual heuristics. The generative AI control logic utilizes algorithmic prompt construction with templated sections tied to machine-readable user profiles, which is not equivalent to a human salesperson drafting instructions by hand. Therefore, the system constitutes an improvement in computer-implemented information processing itself, rather than merely substituting a human with a computer.

In one illustrative example, the server receives speech from a customer who is evaluating a particular product and asking about its price. The terminal records the audio and sends it to the server. The server converts the audio into text and acoustic features, classifies the emotional state as “interested but anxious,” and updates the user profile information accordingly. The server constructs a prompt sentence such as:

“Using the following user profile and current emotional state, create a concise proposal that reassures the user about price and emphasizes the long-term value of Product A. Use polite language and limit the length to approximately 500 words.”

The server sends the prompt sentence to the generative AI model, obtains a personalized proposal text and closing-support text, generates a proposal document data set, and sends it to the terminal. The terminal displays the main points of the proposal and shows on a head-mounted display the message “Customer anxious about price; highlight cost-performance and warranty.” The salesperson then adjusts the explanation in real time. At the same time, the server stores the outcome of the discussion and the emotion trajectory for use in future training.

In another example, the server analyzes past commercial discussion records and purchase histories and identifies that certain proposed items were not purchased. The server composes a prompt sentence such as:

“Based on the following negotiation results and existing purchases, draft a proposal that fills missing product areas and supports closing the deal for the remaining items. Focus on explaining complementary benefits.”

The generative AI model returns a proposal-video script indicating which advantages to emphasize in each scene. The server generates proposal video data, and the terminal plays the video to the customer. The server monitors user reactions and logs both the emotion sequences and transaction outcomes, further enriching the learning information.

Through these operations, the server, the terminal, and the user cooperate in a system that not only automates parts of sales activities but also improves the technical characteristics of computer-implemented emotion analysis, recommendation, generative content control, and multi-language dialogue, achieving improved processing speed, precision, and resource utilization compared to conventional architectures.

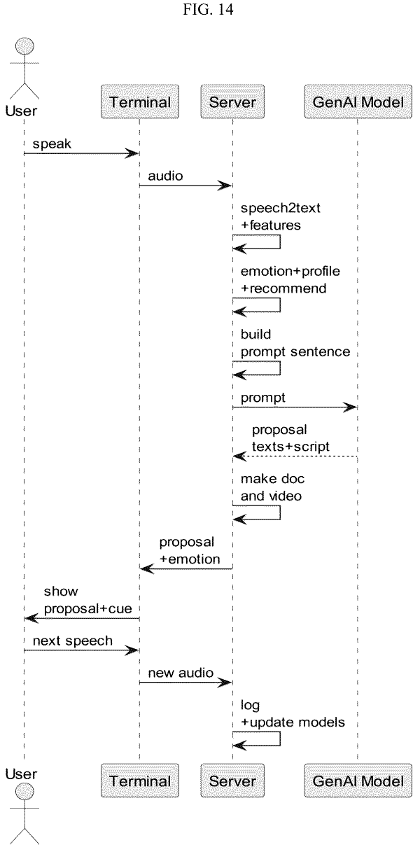

The following describes the processing flow using FIG. 14.

### Step 1:

The terminal captures user voice.

The terminal uses a microphone to record analog speech of a user and converts the analog signal into digital audio samples (input: acoustic pressure; output: digital audio data in a format such as PCM). The terminal segments the audio into frames and packages the frames with metadata including a session identifier, a user identifier, a timestamp, and an estimated language code. The terminal sends the packaged audio data to the server over a secure network connection, thereby performing analog-to-digital conversion and secure encapsulation of the voice stream.

### Step 2:

The server stores and normalizes the received audio.

The server receives the digital audio data from the terminal (input: framed audio samples with metadata; output: a normalized audio file and a database record). The server decodes the audio stream if necessary, applies resampling and amplitude normalization to produce a consistent sampling rate and loudness level, and writes the resulting audio to a storage device.

The server registers a record in a database table that links the file path of the stored audio with the session identifier, user identifier, and timestamps. This data processing step ensures that later modules receive audio in a standard format with stable amplitude characteristics.

### Step 3:

The server performs speech recognition and feature extraction.

The server uses a speech recognition function to convert the normalized audio into text (input: normalized audio file; output: character information and an initial word-time alignment). The server divides the audio into overlapping frames, computes short-term spectral features, and feeds the features into an acoustic model, which outputs phonetic or subword probabilities. The server applies a language model to decode the most probable word sequence, thereby generating character information. In parallel, the server uses an acoustic feature extraction function to compute prosodic features such as average energy, pitch contour, speaking rate, and pause duration (input: normalized audio file; output: acoustic feature information vector). The server writes the character information and acoustic feature information into the database associated with the session.

### Step 4:

The server estimates an emotional state and a psychological state.

The server loads the character information and acoustic feature information from the database (input: text tokens and acoustic feature vectors; output: an emotional state vector and a psychological state record). The server feeds the acoustic feature vectors into an emotion classification neural network, which computes probabilities for emotion labels such as “joy,” “anxiety,” or “dissatisfaction.” The server also applies a text-based sentiment analysis model to the character information and obtains sentiment scores. The server fuses these scores by weighted averaging or another fusion rule to obtain an emotional state vector. The server then maps the emotional state vector into a psychological state record that includes degrees of interest, anxiety, and satisfaction. The server stores this record with a timestamp, thereby performing numerical classification and mapping operations over multimodal input.

### Step 5:

The server updates temporal emotion trajectories.

The server queries the database for all emotional state records associated with the current session and user (input: multiple emotional state vectors over time; output: temporal change information). The server sorts the records by timestamp and creates a time series of emotional labels and intensities. The server computes derivative measures such as the rate of change of anxiety or the cumulative duration of high interest by applying numerical differentiation and time-window aggregation. The server stores the resulting temporal change information in a dedicated structure. This calculation step transforms discrete emotion estimates into continuous trajectories that can be exploited by subsequent models.

### Step 6:

The server analyzes behavior history and builds a user profile.

The server retrieves transaction history information, purchase history information, and browsing history information for the user from storage (input: relational records of transactions, purchases, and web interactions; output: a user profile information record). The server aggregates these data using grouping and summation operations, calculating metrics such as category-wise purchase counts, average spending, and most frequently viewed product types. The server then combines these behavior metrics with the temporal change information of the emotional state, computing composite features such as “high interest during visits to a particular product category.” The server stores these composite features in a user profile information record that represents long-term preferences and short-term tendencies.

### Step 7:

The server generates proposal candidate information.

The server applies a recommendation model to the user profile information (input: user profile features and catalog data; output: proposal candidate information). The server loads item embeddings and user embeddings from a trained model, computes similarity scores between the user embedding and item embeddings, and ranks items according to predicted relevance. The server filters out items that are unavailable or conflict with predefined policy rules, and forms a proposal candidate list with associated scores and tags. The server saves this list as proposal candidate information, thereby performing vector similarity computation and ranking operations on structured data.

### Step 8:

The server constructs a prompt sentence for a generative AI model.

The server reads the user profile information, proposal candidate information, and the latest emotional state (input: structured profile fields, candidate list, and emotional state vector; output: a prompt sentence in natural language). The server assembles the prompt sentence by inserting these data into a predefined template, dividing the text into sections such as role, task, constraints, and context. For example, the server creates a prompt sentence:

“You are a sales advisor. Using the following user profile and current emotional state, create a concise proposal that reassures the user about price and emphasizes the long-term value of the selected products. Use polite language and limit the length to approximately 500 words.”

The server appends summary bullet points describing user interests and key candidate items. The resulting prompt sentence encapsulates machine-readable context into a human-readable instruction suitable for the generative AI model.

### Step 9:

The server invokes the generative AI model and obtains proposal information.

The server sends the prompt sentence to a generative AI model via an application programming interface (input: prompt sentence and generation parameters; output: proposal information including proposal text, closing-support text, and a proposal-video script). The server sets parameters such as maximum output length and randomness, and then receives a token sequence generated by the model. The server decodes the tokens into text and segments the text into labeled parts corresponding to a main proposal, a closing-support section, and a video script composed of scenes and narration. The server stores these texts in the database as proposal information associated with the session.

### Step 10:

The server validates and refines the generated proposal information.

The server analyzes the proposal information to verify compliance with internal rules (input: generated texts; output: validated or revised proposal information). The server checks for required sections, maximum length, and prohibited patterns using pattern-matching and length-measurement operations. If any constraint is violated, the server constructs a revised prompt sentence that includes corrective instructions, such as “Shorten the proposal and remove specific personal identifiers,” and repeats Step 9. The server thus performs iterative control over generative outputs by modifying the input prompt sentence until the generated content satisfies predefined structural criteria.

### Step 11:

The server generates proposal document data and proposal video data.

The server retrieves the validated proposal information (input: proposal text, closing-support text, and proposal-video script; output: proposal document data and proposal video data). The server combines the proposal text and closing-support text with a document template, filling placeholders with content and adjusting layout elements, then exports the filled template as a document file. For video, the server parses the proposal-video script into scene descriptors and time codes, selects corresponding image or video assets from storage, overlays captions or highlights, and synthesizes narration audio using text-to-speech. The server encodes the sequence into a standard video format, creating proposal video data suitable for streaming to terminals.

### Step 12:

The server translates proposal information into multiple languages.

The server applies a translation function to the proposal text and closing-support text (input: original language texts and target language codes; output: multilingual proposal information).

The server splits the texts into segments, sends each segment to a translation engine, receives translated segments, and reassembles them into complete localized texts. The server stores the translated texts as variants indexed by language. This processing step enables the server to provide proposal document data and guidance in different languages without redefining the underlying structure of the proposal.

### Step 13:

The server transmits emotional state and proposals to the terminal.

The server selects the appropriate language version of the proposal document data and extracts a compact representation of the emotional state (input: multilingual proposal information and emotional state vector; output: a transmission packet containing proposal data and emotion indicators). The server encodes symbolic emotion labels and key numeric scores into a short code and combines this with references to the proposal document and video. The server sends this packet to the terminal via a network interface. By sending compact codes instead of full internal vectors, the server reduces communication overhead while preserving sufficient information for the terminal to display meaningful cues.

### Step 14:

The terminal presents the proposal and emotion indicators to the user.

The terminal receives the packet from the server (input: proposal document data, proposal video data, and emotion codes; output: rendered visual and audio content). The terminal decodes the document data and renders the proposal on its display, optionally scrolling or paginating content. The terminal decodes the emotion code into short text messages or icons, such as “User is interested but anxious,” and overlays this information on a head-mounted display or a secondary panel. When video data are included, the terminal plays the video and synchronizes on-screen prompts with the video timeline. The user views the displayed information and adapts speech or actions based on the presented guidance.

### Step 15:

The user interacts with the customer and the system.

The user uses the proposal information and emotion indicators as real-time support during a commercial discussion (input: displayed proposal and emotion cues; output: spoken responses and interaction outcomes). The user may follow suggested phrases from the closing-support text, choose particular benefits to emphasize, or adjust tone and pace of speech. The user's spoken responses and any new questions from the customer are again captured as voice information at the terminal, forming new input for Step 1. The overall system thereby forms a closed loop in which user actions, customer reactions, and generated proposals iteratively influence each other.

### Step 16:

The server logs outcomes and updates learning data.

The server receives outcome information from the terminal or from external transaction systems (input: transaction result information and associated emotion trajectories; output: updated learning information for model training). The server stores whether a deal was closed, what products were purchased, and at what terms, together with the emotional state sequence that preceded the outcome. The server periodically aggregates these records and uses them as labeled data to retrain or fine-tune models for emotion classification, recommendation, and prompt construction. By adjusting model parameters based on this learning information, the server improves prediction accuracy and the quality of future prompt sentences and proposal information, closing the technical feedback loop of the system.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

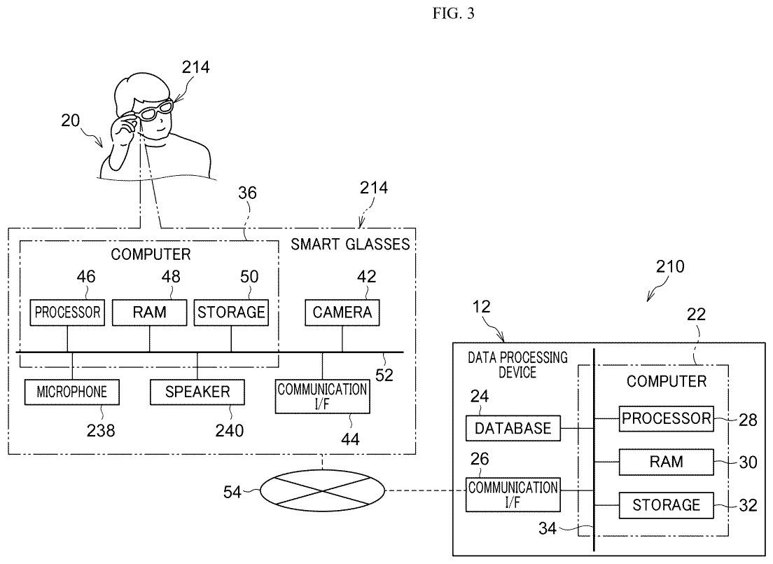

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

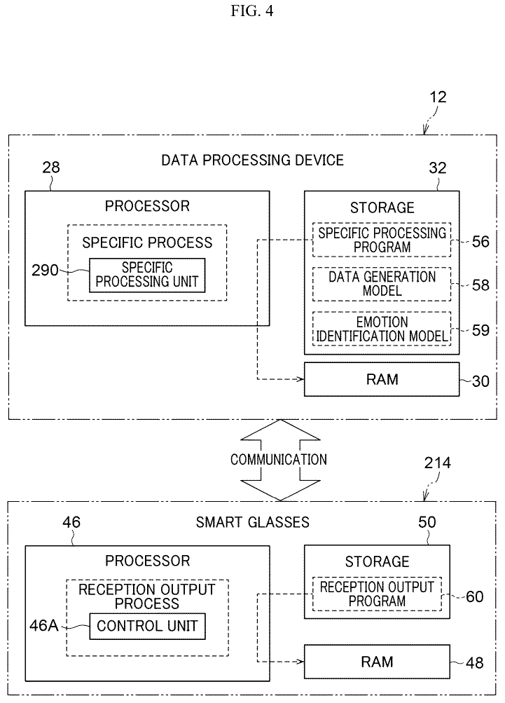

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

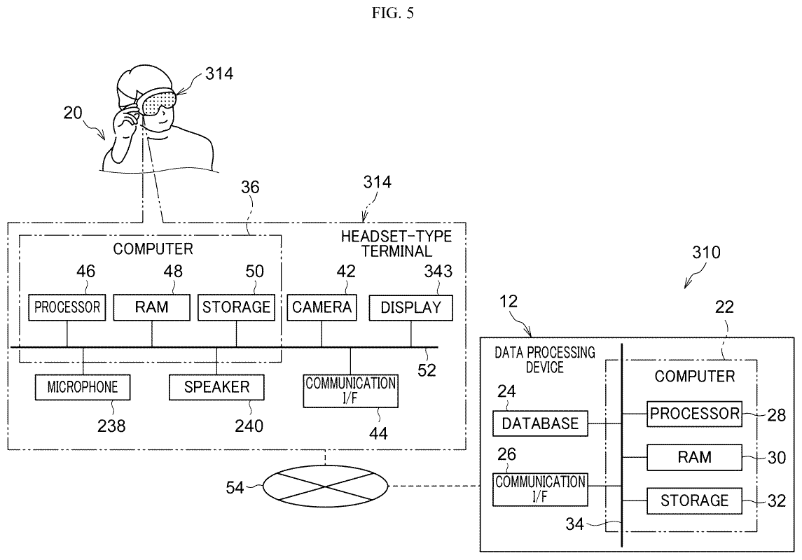

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

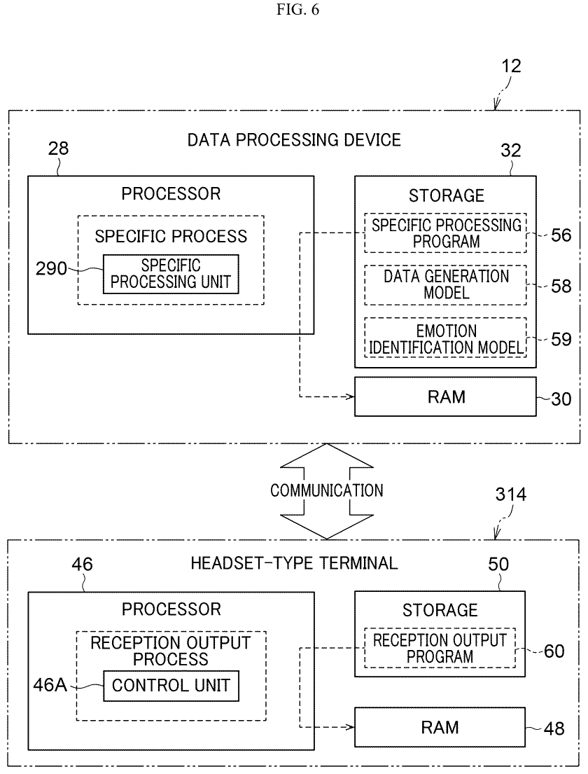

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

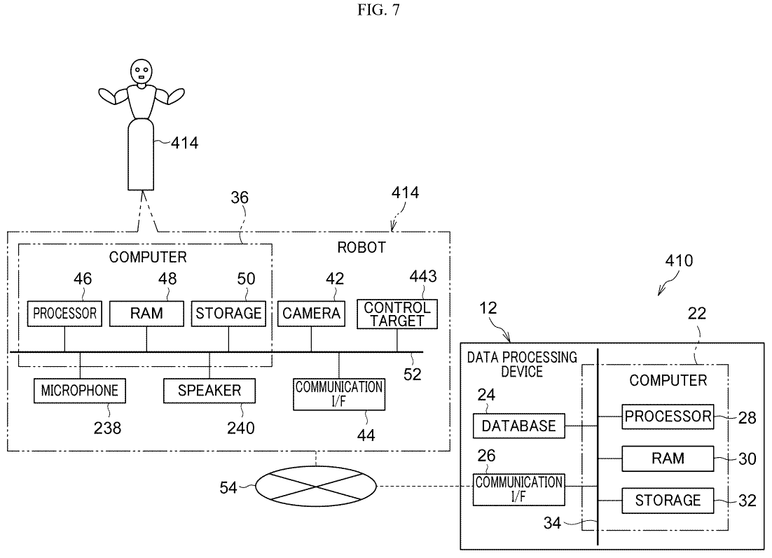

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

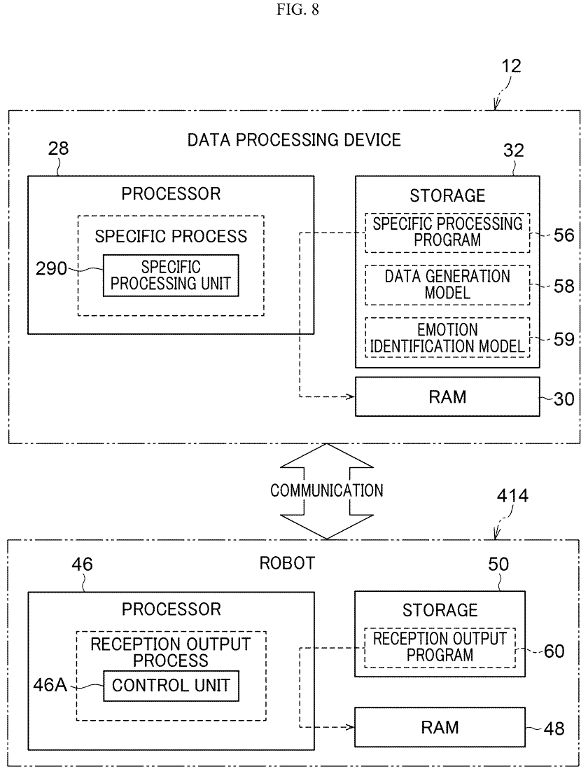

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

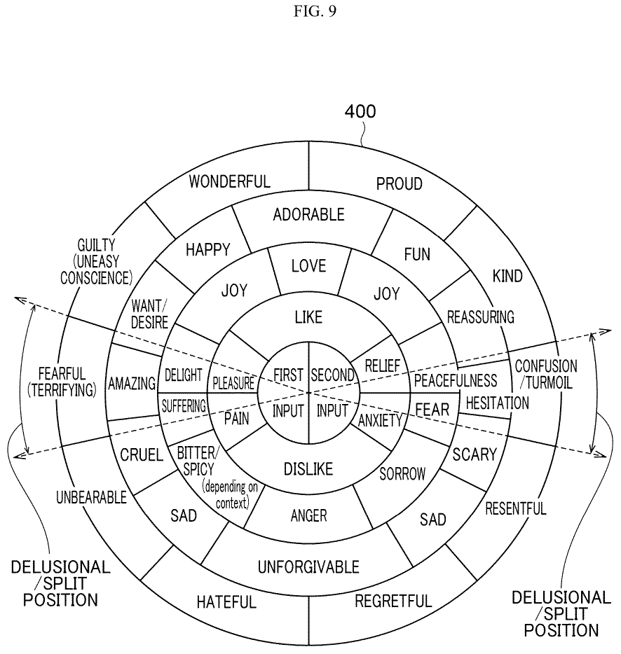

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

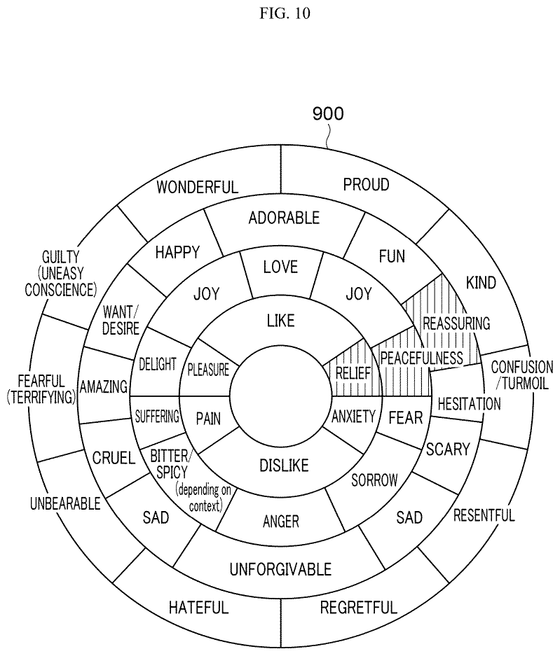

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to function as an information storage unit that accumulates and manages, in a searchable manner, structured data including product information, price information, usage information, and evaluation information, and wherein the processor is configured to function as an analysis unit that receives, via a terminal, a prompt sentence input by a user, performs natural language processing on the prompt sentence including morphological analysis, semantic analysis, and intent estimation, and extracts customer need information and constraint condition information from the prompt sentence, and
wherein the processor is configured to function as a proposal generation unit that, based on the customer need information and the constraint condition information, executes query processing on the information storage unit to acquire product information satisfying conditions, inputs the acquired product information and the customer need information as context to a generative AI model, and generates a personalized proposal sentence in natural language, and
wherein the processor is configured to control the terminal so that the terminal functions as a presentation unit that presents the personalized proposal sentence generated by the proposal generation unit to the user by screen display or audio output, and
wherein the processor is configured to control the terminal so that the terminal functions as a voice acquisition unit that acquires a voice of a customer during a business negotiation by a sound collection device and transmits corresponding voice data to the processor, and
wherein the processor is configured to function as a psychological state analysis unit that performs speech recognition processing and acoustic feature analysis processing on the voice data, estimates customer psychological state information based on tone, volume, speaking speed, and speech pattern, and inputs the psychological state information and business negotiation situation information as context to the generative AI model to generate a guidance sentence or a revised proposal sentence including a response policy for the user, emphasis points of explanation content, and additional information to be input, and
wherein the processor is configured to control the terminal so that the terminal functions as a business negotiation support unit that presents the guidance sentence or the revised proposal sentence generated by the psychological state analysis unit to the user during the business negotiation and supports real-time adjustment of explanation content by the user.

### (Supplementary 2)

The system according to supplementary 1,
wherein the processor is configured to function as a follow-up proposal generation unit that compares result information of the business negotiation with history information related to existing purchasers accumulated in the information storage unit, identifies missing product categories, functions, or service conditions, generates, by using the generative AI model, a follow-up proposal sentence, proposal document structure information, or proposal video script that supplements the missing parts, and transmits the generated follow-up proposal sentence, proposal document structure information, or proposal video script to the terminal.

### (Supplementary 3)

The system according to supplementary 1,
wherein the processor is configured to function as a multilingual support unit that combines natural language processing and machine translation to mutually convert, between a plurality of languages, the prompt sentence input by the user, the proposal sentence and the guidance sentence generated by the generative AI model, and customer utterance text obtained by speech recognition, thereby enabling provision of personalized proposals based on a common proposal logic to customers using different languages.

### Application Example 1

### (Supplementary 1)

A system comprising a processor,
wherein the processor is configured to
acquire conversational audio data, divide the conversational audio data into audio segments in a predetermined audio format, and transmit the audio segments via a communication path, perform speech recognition processing on the conversational audio data to generate character information, and perform natural language processing including speaker discrimination processing and intent extraction processing on the character information to obtain customer request information as structured information,
extract acoustic feature information based on the conversational audio data, extract emotion information based on the character information, and estimate customer psychological state information based on the acoustic feature information and the emotion information, search an information storage apparatus storing merchandise information including merchandise attribute information, price information, usage information, and evaluation information, acquire candidate merchandise information in accordance with the customer request information and the customer psychological state information, and perform suitability evaluation and ranking on the candidate merchandise information,
construct a prompt sentence for a generative AI model based on the customer request information, the customer psychological state information, and the candidate merchandise information, and include, in the prompt sentence, an output tone and an explanation style corresponding to the customer psychological state,
input the prompt sentence and the candidate merchandise information to the generative AI model, cause the generative AI model to generate response information including personalized merchandise proposal information, and convert the response information into display structure data,
transmit the display structure data to a visual information display device, and cause the visual information display device to display the merchandise proposal information in real time to support sales activities to a plurality of customers by a small number of operators, and record the conversational audio data, the character information, the customer request information, the customer psychological state information, and the merchandise proposal information in association with one another, and generate learning data for updating the intent extraction processing, the psychological state estimation, and a configuration method of the prompt sentence based on the record.

### (Supplementary 2)

The system according to supplementary 1,
wherein the processor is configured to
generate, in constructing the prompt sentence, a follow-up prompt sentence sequentially based on reaction information of the customer obtained from the conversational audio data and the character information, and operation information of the operator, and input the follow-up prompt sentence to the generative AI model to cause the generative AI model to generate additional proposal information stepwise in response to an additional request or an objection of the customer.

### (Supplementary 3)

The system according to supplementary 1,
wherein the processor is configured to
perform, in generating the display structure data, a machine translation process that converts the merchandise proposal information from a first natural language into a second natural language, and cause the visual information display device to display the merchandise proposal information in the second natural language as multilingual support processing.

### Example 2

### (Supplementary 1)

A system comprising a processor,
wherein the processor is configured to
generate a prompt sentence instructing a generative AI model to automate an operational procedure in order to alleviate shortage of human resources and to perform information provision or transaction activities efficiently for a plurality of targets,
generate a prompt sentence instructing analysis of attribute information of a target and dialogue content by using natural language processing and generation of proposal information individually optimized for each target,
generate a prompt sentence instructing reception, from a terminal, of voice data obtained from the target and execution of preprocessing on the voice data including noise reduction and volume normalization,
generate a prompt sentence instructing extraction, from the preprocessed voice data, of acoustic feature values including tone, volume, speaking speed, and speech pattern by using a voice analysis algorithm,
generate a prompt sentence instructing input of the acoustic feature values to a generative AI model and execution of an analysis process for estimating a psychological state of the target on the basis of learning data, and
generate a prompt sentence instructing generation, by the generative AI model, of guidance information including a negotiation policy or response policy on the basis of the estimated psychological state, domain-specific knowledge, and a prompt sentence input by a user, and output of the guidance information to the terminal.

### (Supplementary 2)

The system according to supplementary 1,
wherein the processor is configured to
generate a prompt sentence instructing comparison of the estimated psychological state and progress information of a dialogue with past successful case data and generation of support information including explanatory content, question content, or material structure for supplementing insufficient elements.

### (Supplementary 3)

The system according to supplementary 1,
wherein the processor is configured to
generate a prompt sentence instructing execution of processing for presenting the guidance information in a plurality of languages by using machine translation in accordance with a language type and regional information of the target.

### Application Example 2

### (Supplementary 1)

A system comprising a processor,
wherein the processor is configured to
acquire voice information from a user terminal and convert the voice information into character information and acoustic feature information by using a speech recognition function and an acoustic feature extraction function, and estimate an emotional state and a psychological state of a user on the basis of the character information and the acoustic feature information,
analyze, by using an information analysis function and a machine learning function, temporal change information of the emotional state and the psychological state together with behavior history information including transaction history information, purchase history information, and browsing history information, and generate user profile information including at least a degree of interest, a degree of anxiety, and a degree of satisfaction of the user and generate proposal candidate information,
generate a prompt sentence for a generative information processing model on the basis of the user profile information, the proposal candidate information, and the emotional state, the prompt sentence instructing the generative information processing model to automatically execute at least a part of a sales process, and obtain proposal information including at least a personalized proposal text, a closing-support text, and a proposal-video script from the generative information processing model,
process the proposal information into proposal document data and proposal video data by using a document generation function and a video generation function, and provide the proposal document data and the proposal video data to the user terminal,
transmit, in real time, the proposal information and the emotional state to a user terminal including a visual display device, and support face-to-face interaction by causing the visual display device to display the emotional state and a recommended response during a commercial discussion,
store past transaction result information, inquiry information, explanation material information, and the emotional state as learning information, and update operation parameters of the machine learning function and the generative information processing model so as to improve accuracy of generation of future proposal information and prompt sentences, and convert the proposal information and the closing-support text into a plurality of languages by using a natural language processing function and a machine translation function, and generate multilingual proposal information for performing automatic responses irrespective of time.

### (Supplementary 2)

The system according to supplementary 1,
wherein the processor is configured to use an information analysis function to compare commercial discussion result information with purchased-user information, identify product groups and service groups that were presented in the commercial discussion but have not been purchased, and incorporate identification results into the prompt sentence so as to instruct the generative information processing model to generate the proposal document data and the proposal video data that complement missing portions.

### (Supplementary 3)

The system according to supplementary 1,
wherein the processor is configured to include, in the prompt sentence, control conditions for dynamically changing tone of wording, emphasis points, and price-presentation policy of proposal content in accordance with the emotional state of the user, the user profile information, and the proposal candidate information, and instruct the generative information processing model to generate emotion-adaptive proposal information and closing-support text.

What is claimed is:

1. A system comprising:
circuitry configured to:
receive, via a communication interface coupled to a packet-switched network, a prompt sentence expressed in natural language from a terminal device, and perform natural language processing on the prompt sentence including morphological analysis, semantic embedding computation, and intent classification to extract customer need information and constraint condition information as structured records;
execute query processing on a product information storage device using the customer need information and the constraint condition information as structured query conditions, and rank candidate product records by a relevance scoring function combining attribute match scores and rating values;
construct model input data by assembling the prompt sentence, the customer need information, and the ranked candidate product records into a structured context sequence, and operate a generative neural network model using the model input data to generate a personalized proposal and transmit the personalized proposal to the terminal device via the communication interface;
receive, via the communication interface, voice data acquired by a sound collection device of the terminal device during a negotiation, perform speech recognition processing and acoustic feature analysis processing on the voice data to extract pitch contours, energy levels, speech rate values, and pause pattern features, and apply a psychological state classifier to the extracted features to generate psychological state information including an estimated engagement level and anxiety indicator; and
construct guidance model input data including the personalized proposal, recognized utterance text, and the psychological state information, and operate the generative neural network model using the guidance model input data to generate a guidance output including a response policy and explanation emphasis points, and transmit the guidance output to the terminal device via the communication interface.

2. The system according to claim 1, wherein the circuitry is configured to perform the intent classification by applying a transformer-based intent classification network to the semantic embedding computed for the prompt sentence, determining one or more intent categories from a predefined set including budget constraint, feature requirement, and quantity requirement, and mapping detected entities extracted by a named entity recognition model to corresponding fields of the structured records.

3. The system according to claim 2, wherein the circuitry is configured to execute the query processing by constructing database queries that include equality conditions, range conditions, and sorting conditions derived from the structured records, executing the queries against an indexed relational data store containing product attribute data, price data, usage data, and evaluation data, and applying a ranked retrieval algorithm on free-text fields using an inverted index.

4. The system according to claim 3, wherein the circuitry is configured to perform constrained decoding when operating the generative neural network model by masking token probabilities to prevent generation of tokens that contradict known product attributes or constraint condition values, and selecting output tokens using beam search or nucleus sampling.

5. The system according to claim 4, wherein the circuitry is configured to construct the model input data by formatting the customer need information and ranked candidate product records into a structured prompt template including an instruction portion, a customer need portion, and a product context portion, and tokenizing the template into an input token sequence for the generative neural network model.

6. The system according to claim 1, wherein the circuitry is configured to perform the acoustic feature analysis processing by computing pitch contour values by fundamental frequency extraction, computing energy levels by root-mean-square amplitude analysis over fixed-duration frames, computing speech rate values by measuring syllable or word count per unit time, and detecting pause pattern features by identifying silence intervals exceeding a duration threshold.

7. The system according to claim 6, wherein the circuitry is configured to apply the psychological state classifier by aggregating the extracted features into fixed-length feature vectors for temporal segments of the voice data, and applying a neural network combining convolutional layers for local feature extraction and sequential layers for temporal modeling to map the feature vectors to psychological state probability distributions over states including high interest, cost anxiety, confusion, and agreement tendency.

8. The system according to claim 7, wherein the circuitry is configured to compute psychological state trend information by analyzing a sequence of psychological state estimates over time, detect a direction of change in an engagement level indicator, and incorporate the trend information into the guidance model input data to condition generation of the guidance output on both current state and temporal dynamics.

9. The system according to claim 1, wherein the circuitry is configured to, after a negotiation is concluded, receive negotiation result information including purchased items, rejected items, and customer feedback from the terminal device, compare the negotiation result information with history information of existing purchasers accumulated in the product information storage device using a similarity-based retrieval procedure, identify product categories and service conditions that are present in purchases of similar existing purchasers but absent from the negotiation result information, and generate follow-up proposal data based on the identified absent items using the generative neural network model.

10. The system according to claim 9, wherein the circuitry is configured to perform the similarity-based retrieval procedure by computing a feature vector representation of the negotiation result information, querying the product information storage device to retrieve purchaser records having feature vector similarity above a threshold, aggregating item frequency counts across the retrieved purchaser records, and selecting absent item candidates whose frequency counts exceed a minimum support threshold.

11. The system according to claim 10, wherein the circuitry is configured to operate the generative neural network model using model input data including the negotiation result information, the identified absent item candidates, and a follow-up proposal instruction to generate at least one of a follow-up proposal sentence, proposal document structure information specifying sections and item listings, or a proposal video script specifying narration and visual elements, and transmit the generated follow-up proposal data to the terminal device via the communication interface.

12. The system according to claim 1, wherein the circuitry is configured to receive a prompt sentence in a first language, detect the first language, apply a machine translation model to convert the prompt sentence to a base processing language when the first language differs from the base processing language, execute the natural language processing and generative neural network model operations in the base processing language, and apply the machine translation model to convert the generated personalized proposal and guidance output to the first language before transmission to the terminal device.

13. The system according to claim 12, wherein the circuitry is configured to maintain language-independent representations of the customer need information and constraint condition information during query processing and model inference, so that product selection and proposal composition logic operates consistently regardless of the external language, and perform translation only at input and output boundaries of the processing pipeline.

14. The system according to claim 1, wherein the circuitry is configured to store each prompt sentence and corresponding personalized proposal as history information associated with a session identifier in the product information storage device, and upon receiving a subsequent prompt sentence from the terminal device, retrieve prior session history information and compute a semantic similarity score between the subsequent prompt sentence and prior prompt sentences using embedding vector cosine similarity, and condition the generative neural network model on the retrieved history information when the semantic similarity score exceeds a threshold.

15. The system according to claim 14, wherein the circuitry is configured to receive feedback signals from the terminal device indicating whether a generated personalized proposal was presented and resulted in a positive customer response, store the feedback signals in association with the corresponding prompt sentence, product query conditions, and proposal content in the product information storage device, and use the stored feedback signals as training pairs to update parameters of the generative neural network model or the intent classification network via gradient-based optimization.

16. The system according to claim 1, wherein the circuitry is configured to transmit the psychological state information and the guidance output to the terminal device in real time during the negotiation for display in a guidance area of the terminal device that is separate from customer-facing content, and include in the guidance output urgency level indicators derived from detected changes in the psychological state information.

17. The system according to claim 1, wherein the circuitry is configured to store the voice data, the psychological state information, the negotiation result information, and the generated guidance output as training data in the product information storage device, and update operational parameters of the psychological state classifier and the generative neural network model based on labeled training examples derived from the stored training data to improve accuracy of psychological state estimation and proposal generation.

18. A system comprising:
circuitry configured to:
receive, via a communication interface coupled to a packet-switched network, a prompt sentence from a terminal device, and perform natural language processing including tokenization, morphological analysis, transformer-based semantic embedding, intent classification, and named entity recognition to extract customer need information and constraint condition information as structured records with budget fields, feature flags, and priority scores;
execute structured database queries on a product information storage device using the extracted constraint condition information as equality and range conditions on indexed product attribute columns, rank retrieved candidate product records by a relevance scoring function, and construct a structured prompt template assembling the prompt sentence, the customer need information, and top-ranked candidate product attributes;
operate a transformer-based generative neural network model using the structured prompt template as input to generate a personalized proposal sentence with constrained decoding that prevents tokens contradicting known product attributes, and transmit the personalized proposal sentence to the terminal device via the communication interface;
receive voice data from the terminal device, execute a speech recognition model to convert the voice data to recognized utterance text, compute acoustic feature vectors including pitch contour values, energy levels, speech rate values, and pause pattern features for temporal segments, and apply a sequential neural network classifier to the acoustic feature vectors to generate psychological state information including engagement level, anxiety indicator, and interest trend signals; and
construct guidance model input data including the recognized utterance text, the psychological state information, and negotiation context, operate the generative neural network model using the guidance model input data to generate a guidance sentence specifying response policy, emphasis points, and revision suggestions, and transmit the guidance sentence to the terminal device via the communication interface.

19. The system according to claim 18, wherein the circuitry is configured to, after a negotiation is concluded, compare negotiation result information received from the terminal device against history information of existing purchasers in the product information storage device using a similarity-based retrieval procedure that computes feature vector similarity between the negotiation result and stored purchaser records, identify absent product categories based on frequency counts among similar purchasers, and operate the generative neural network model to generate follow-up proposal content including at least one of a follow-up proposal sentence, proposal document structure information, or a proposal video script specifying narration and visual elements.

20. A method comprising:
receiving, via a communication interface coupled to a packet-switched network, a prompt sentence expressed in natural language from a terminal device, and performing natural language processing on the prompt sentence including morphological analysis, semantic embedding computation, and intent classification to extract customer need information and constraint condition information as structured records;
executing query processing on a product information storage device using the customer need information and the constraint condition information as structured query conditions, and ranking candidate product records by a relevance scoring function combining attribute match scores and rating values;
constructing model input data by assembling the prompt sentence, the customer need information, and the ranked candidate product records into a structured context sequence, and operating a generative neural network model using the model input data to generate a personalized proposal and transmit the personalized proposal to the terminal device via the communication interface;
receiving, via the communication interface, voice data acquired by a sound collection device of the terminal device during a negotiation, performing speech recognition processing and acoustic feature analysis processing on the voice data to extract pitch contours, energy levels, speech rate values, and pause pattern features, and applying a psychological state classifier to the extracted features to generate psychological state information including an estimated engagement level and anxiety indicator; and
constructing guidance model input data including the personalized proposal, recognized utterance text, and the psychological state information, and operating the generative neural network model using the guidance model input data to generate a guidance output including a response policy and explanation emphasis points, and transmitting the guidance output to the terminal device via the communication interface.
